(19) United States
(12) Patent Application Publication
(10) Pub. No.: US 2025/0175114 A1
(43) Pub. Date: May 29, 2025

(54) MOBILE SOLAR GENERATOR

(71) Applicant: TRYSTAR, LLC, Faribault, MN (US)

(72) Inventors: Casimir A. SIENKIEWICZ, Minneapolis, MN (US); Brett C. NEUBAUER, Eagan, MN (US); Joshua J. HUESMAN, Saint Paul, MN (US); Timothy Frederick MCCARTHY, Plymouth, MN (US); Aaron Robert PADRNOS, Eagan, MN (US); Robert R. ROBERTS, III, Saint Paul, MN (US); Christopher Todd TACHENY, Dundas, MN (US); Travis E. YOCH, Woodbury, MN (US); Phillip Wayne PAKES, Inver Grove Heights, MN (US); Jack Mills ZIMMERMAN, Faribault, MN (US)

(21) Appl. No.: 19/038,070

(22) Filed: Jan. 27, 2025

Related U.S. Application Data
(63) Continuation-in-part of application No. PCT/US2023/028862, filed on Jul. 27, 2023.
(60) Provisional application No. 63/512,166, filed on Jul. 6, 2023.
(60) Provisional application No. 63/392,535, filed on Jul. 27, 2022.

(51) Int. Cl. H02S 10/40; H02S 20/32; H02S 40/42

(52) U.S. Cl. CPC H02S 10/40; H02S 20/32; H02S 40/425

(57) ABSTRACT

A mobile solar generator can include a housing, wheels and outriggers coupled to the housing, a solar array including solar panel(s), a user interface, and a controller in communication with the user interface. The mobile solar generator can include a sensor tower supporting wind sensor. The outriggers, solar array, and/or weather tower can be configured to be stored and/or deployed. The solar array orientation can be adjusted to track the position of the sun, for example, based on a determined facing direction of the mobile solar generator. The solar array can be configured to enter into a safe-mode configuration in response to certain weather conditions such as high winds. The mobile solar generator can generate electrical energy and include one or more batteries and/or a nonrenewable energy source. A controller can control various functions of the mobile solar generator.

### RELATED APPLICATIONS

This application is a continuation-in-part of International Patent Application No. PCT/US2023/028862, filed Jul. 27, 2023, which claims the benefit of U.S. Provisional Application No. 63/392,535, filed Jul. 27, 2022, and the benefit of U.S. Provisional Application No. 63/512,166, filed Jul. 6, 2023, the contents of each of which is incorporated herein by reference in its entirety.

### TECHNICAL FIELD

Aspects of this disclosure relate to mobile generators.

### BACKGROUND

Solar panels have traditionally been installed in fixed locations where they can generate power which can then be distributed to the electrical systems. Many solar panels are also installed at fixed angles to keep installation and maintenance costs down. Some solar panels are transportable, such as those used for camping, camping vehicles, mobile security cameras, etc., but these solar panels usually are small in terms of electricity generated and require human interaction to set up.

### SUMMARY

Some aspects of this disclosure are directed to a mobile solar generator. In various examples, mobile solar generators can comprise a housing, wheels and outriggers coupled to the housing, a solar array including one or more solar panels that can receive electromagnetic radiation and generate electrical energy, a user interface, and a controller in communication with the user interface and other components.

Some mobile solar generators include an adjustable support pillar configured to extend from a housing and a multi-axis pivot connecting the solar array to the adjustable support pillar. In some such cases, the height of the solar array is adjustable via the adjustable support pillar. In some cases, the solar array is configured to move about at least two axes relative to the adjustable support pillar, and a height of the solar array is adjustable via the adjustable support pillar.

In some embodiments, a mobile solar generator includes a solar array drive system controllable by a controller. The solar array drive system can move the solar array, such as about the at least two axes. In some examples, the solar array drive system moves the solar array to track the sun. A mobile solar generator can include components such as a GPS and a compass to facilitate tracking the sun. For instance, in some examples, a mobile solar generator is portable, such as being towable behind a vehicle, and the mobile solar generator can be brought to and used at various locations and can face different directions. Components such as a GPS and compass can be used to determine motion of the solar array to track the sun given the location and facing direction the mobile solar generator, even if the mobile solar generator is brought to different locations.

In some examples, the solar array is movable between a stored solar array configuration and a deployed solar array configuration. In some examples, the stored solar array configuration facilitates easier transportation of the mobile solar generator, while the deployed solar array configuration increases the amount of power that the mobile solar generator can generate from the solar array.

In some embodiments, the mobile solar generator comprises a plurality of outriggers coupled to the housing. The outriggers include an arm extendable outwardly from the housing, a leg extendable downwardly from the arm's distal end, and a foot coupled to the leg's bottom surface. The outriggers can move between a stored outrigger configuration and a deployed outrigger configuration, wherein the foot of the outrigger extends to the ground. In some examples, the outriggers can raise the mobile solar generator such that one or more wheels of the mobile solar generator are raised off of the ground and can be adjusted to level the housing. In some examples, a controller controls the movement of the outriggers, for example, via one or more hydraulic actuators. In some examples, in response to command(s) received from the user interface, the controller causes the outriggers and solar array to move from their stored configurations to their deployed configurations.

Some embodiments of the mobile solar generator comprise a wind sensor, for example, supported by a sensor tower. In some such examples, the controller receives wind information from the wind sensor representative of a wind strength, and if the solar array is in the deployed configuration and the wind information satisfies a predetermined threshold, the controller moves the solar array into a safe mode configuration different from the deployed configuration. Moving the solar array to a safe mode can prevent damage that may otherwise occur due to high winds when the solar array is fully deployed.

An example solar array comprises a first section having a top surface and a bottom surface and comprising a first set of one or more solar panels and a second section having a top surface and a bottom surface and comprising a second set of one or more solar panels. The second section can be pivotable relative to the first section about an axis. In some cases, the solar array is movable between a closed configuration wherein the second section is positioned underneath the first section such that the bottom surface of the second section faces the bottom surface of the first section, and a deployed configuration the top surface of each of the first section and the second section are coplanar. In some such examples, moving the solar array from the closed configuration to the deployed configuration comprises rotating the second section 180 degrees about the axis. In some examples, the solar array comprises a four-bar linkage coupled to the first section and the second section and a linear actuator configured to move an element of the four-bar linkage to move the solar array between the closed configuration and the deployed configuration.

In some embodiments, the solar array comprises a first section having a top surface and a bottom surface and comprising a first set of one or more solar panels, a second section having a top surface and a bottom surface and comprising a second set of one or more solar panels, and a third section having a top surface and a bottom surface and comprising a third set of one or more solar panels, and is movable between a closed configuration and a deployed configuration. In some such examples, in the closed configuration, the third section is covered by the second section and the second section is covered by the first section, and in the deployed configuration, none of the first, second, or third sections are covered by any other of the first, second, or third sections and the top surface of each of the first, second, and third section face an outward direction. In some examples, as the solar array moves between the closed configuration and the deployed configuration, the first section and the third section remain parallel to one another.

### BRIEF DESCRIPTION OF DRAWINGS

The following drawings are illustrative of particular embodiments of the present invention and therefore do not limit the scope of the invention. The drawings are not necessarily to scale (unless so stated) and are intended for use in conjunction with the explanations in the following description. Embodiments of the invention will hereinafter be described in conjunction with the appended drawings, wherein like numerals denote like elements.

FIG. 1 is a perspective view of an example mobile solar generator according to some aspects of the present disclosure.

FIG. 2A shows an example outrigger configuration according to some aspects of the present disclosure.

FIG. 2B shows a cross-sectional side view of an example outrigger leg and foot according to some aspects of the present disclosure.

FIG. 3 shows an example mobile solar generator comprising outriggers in a deployed configuration according to some aspects of the present disclosure.

FIGS. 4A and 4B are front and rear perspective views, respectively, of an example mobile solar generator according to some aspects of the present disclosure.

FIG. 5 is a system diagram of a controller in communication with an outrigger drive system and a solar array drive system in example mobile solar generator according to some aspects of the present disclosure.

FIG. 6 is a flow diagram showing an example outrigger deployment process and solar array deployment process of an example mobile solar generator according to some aspects of the present disclosure.

FIG. 7 is a system diagram showing components of an example mobile solar generator for solar tracking according to some aspects of the present disclosure.

FIG. 8 shows an example process flow diagram showing a method for tracking the sun by a mobile solar generator according to some aspects of the present disclosure.

FIG. 9A shows an example process flow diagram illustrating an example method for positioning a solar array in a first or updated position according to some aspects of the present disclosure.

FIG. 9B shows an alternate example process diagram for positioning the solar array in an orientation according to some aspects of the present disclosure.

FIG. 10 shows a bottom perspective view of a portion of an example mobile solar generator according to some aspects of the present disclosure.

FIG. 11 shows an example battery compartment within a mobile solar generator housing according to some aspects of the present disclosure.

FIG. 12 shows an example mobile solar generator chassis according to some aspects of the present disclosure.

FIG. 13 is a system diagram showing an example battery compartment climate control system according to some aspects of the present disclosure.

FIG. 14A shows an example diagram showing various aspects of a mobile solar generator according to some aspects of the present disclosure.

FIG. 14B shows a plurality of mobile solar generators configured to provide power to a central hub.

FIG. 15 shows an example process of charging one or more batteries according to some aspects of the present disclosure.

FIG. 16 is a back view of an example mobile solar generator according to some aspects of the present disclosure.

FIG. 17 shows an example process flow diagram showing example response of the mobile solar generator to wind information according to some aspects of the present disclosure.

FIG. 18 is a system diagram of an example mobile solar generator according to some aspects of the present disclosure.

FIGS. 19A-19E show configurations of an example solar array moving between configurations according to some aspects of the present disclosure.

FIG. 20A shows an example solar array deployment mechanism according to some aspects of the present disclosure.

FIG. 20B shows an alternate view of the mechanism of FIG. 20A according to some aspects of the present disclosure.

FIG. 21 shows a perspective view of the solar array assembly of FIG. 20A according to some aspects of the present disclosure.

FIGS. 22A-22E are perspective views of an example mobile solar generator in a closed configuration according to some aspects of the present disclosure.

FIGS. 23A-23B are perspective views of an example mobile solar generator in an open configuration according to some aspects of the present disclosure.

FIGS. 24A-24B are perspective views of an example mobile solar generator in an open configuration according to some aspects of the present disclosure.

FIG. 25 is a perspective view of an example mobile solar generator in an open configuration with a sensor tower according to some aspects of the present disclosure.

FIGS. 26A-26B are perspective views of multiple example mobile solar generators transported on a trailer according to some aspects of the present disclosure.

FIGS. 27A-27B are perspective views of an example mobile solar generator with a sliding array of solar panels in both an open configuration and a closed configuration according to some aspects of the present disclosure.

FIGS. 28A-28D are perspective views of an example sliding mechanism for an array of solar panels according to some aspects of the present disclosure.

FIGS. 29A-29B are perspective views of an example mobile solar generator with a folding array of solar panels in both an open configuration and a closed configuration according to some aspects of the present disclosure.

FIGS. 30A-30B are perspective views of an example folding mechanism for an array of solar panels according to some aspects of the present disclosure.

FIG. 31 is a perspective view of an example mobile solar generator with a folding array of solar panels in a half-way open configuration according to some aspects of the present disclosure.

FIGS. 32A-32C are perspective views of an example folding array of solar panels unfolding according to some aspects of the present disclosure.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, and/or dimensions are provided for selected elements. Those skilled in the art will recognize that many of the noted examples have a variety of suitable alternatives.

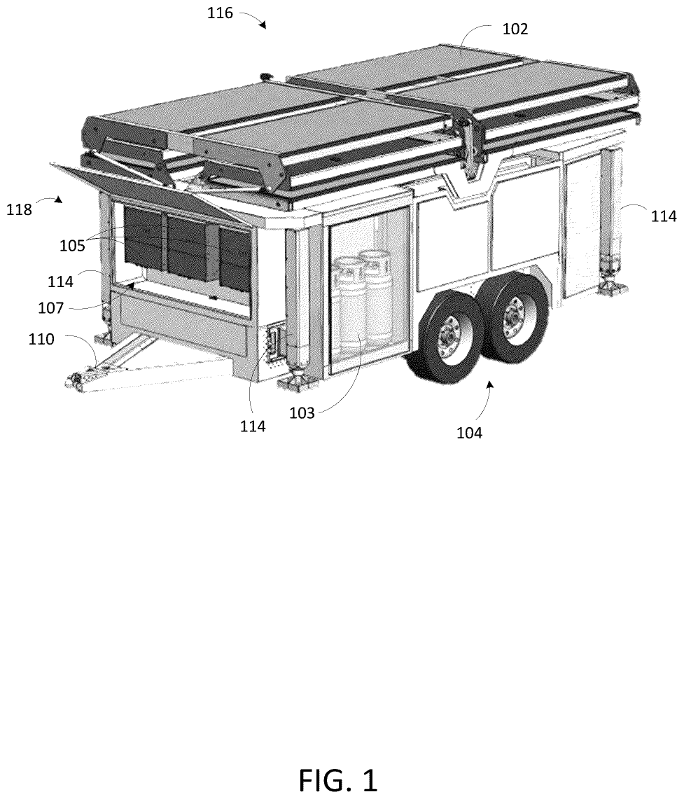

FIG. 1 is a perspective view of an example mobile solar generator 100, which can be in the form of a pull-behind unit with wheels 104. The illustrated example includes four wheels 104, but various embodiments can have any number of wheels, for example, 2 wheels, 4 wheels, 6 wheels, or more. In some cases, a number of wheels can depend on the weight of the mobile solar generator The mobile solar generator of FIG. 1 comprises a trailer hitch 110 such that the mobile solar generator can be pulled behind a vehicle. In some examples, for instance, in some two-wheel embodiments, the trailer hitch 110, when mounted to a vehicle, can support the mobile solar generator 100 and facilitate the unit standing. In other examples, mobile solar generator 100 can be self-supporting and not require a connection to a towing vehicle to stand, for example, due to the wheels 104 being positioned in a location to fully support the mobile solar generator 100 in a standing configuration.

The mobile solar generator 100 includes a series of solar panels 102 in a solar array 116 supported by a housing 118. In some embodiments, the series of solar panels 102 are mounted to the mobile solar generator 100 via an adjustable support pillar with a multi-axis pivot (e.g., a gimbal) as described elsewhere herein. In some examples, solar array 116 is configured to move between a stored solar array configuration and a deployed solar array configuration.

Optionally, the mobile solar generator 100 can include a generator that runs on fuel (e.g., propane) in addition to the series of solar panels 102. In some examples, the generator is configured to generate electrical energy from a non-renewable source. In some embodiments, the generator comprises a propane generator, a diesel generator, or a fuel cell. In some examples, the generator comprises a 6.5 kW propane generator configured to output up to 54 amps at 120 VAC. The generator can be used as a backup generator or as a supplemental generator to provide power when the series of solar panels cannot provide enough power for a load and/or for charging one or more batteries by themselves. In some examples, the mobile solar generator 100 includes one or more batteries that can be used to power a load. In some embodiments, a mobile solar generator includes one or more batteries and a generator that runs on fuel and does not include any solar panels.

In examples which include a generator, the mobile solar generator includes a refillable fuel source container for storing fuel for the generator. For example, the mobile solar generator 100 of FIG. 1 further includes storage for holding propane 103 or other fuel sources. In some examples, mobile solar generator 100 includes a fuel storage compartment configured to hold up to three 43-pound propane tanks.

In some examples, mobile solar generator 100 includes one or more inverters 105 configured to receive DC power (e.g., from one or more solar panels, from one or more batteries, and/or from a generator) and output AC power. In some examples, such one or more inverters comprises one or more off-the-shelf inverters. In various embodiments, inverters can be selected or otherwise configured to output AC power at any desired voltage and frequency. In some embodiments, inverters are configured to output between 100 VAC and 120 VAC at between 50 Hz and 60 Hz. In some embodiments, the mobile solar generator 100 is configured to output three-phase power. In some examples, the mobile solar generator is configured to output between 100 VAC and 150 VAC line to neutral and/or between 180 VAC and 220 VAC phase to phase. In an example embodiment, the mobile solar generator is configured to output 120 VAC in a single-phase output at 60 Hz, 208 VAC in a single phase output at 60 Hz, or 208 VAC in a three-phase output at 60 Hz. In some embodiments, the voltage output can be selectable via a user interface or otherwise defined by one or more outputs used by a user. In some examples, the mobile solar generator can output up to 250 amps at 120 VAC single-phase, up to 144 amps at 208 VAC single-phase, and up to 83 amps at 208 VAC three-phase. In the example of FIG. 1, inverters 105 are shown in an inverter compartment 107 in housing 118.

In some examples, mobile solar generator 100 includes a plurality of outrigger 114 that can be deployed to engage the ground to, for example, stabilize the mobile solar generator 100 and/or prevent the mobile solar generator 100 from rolling on wheels. In the example of FIG. 1, outriggers 114 are shown in a stored outrigger configuration, for example, for transporting the mobile solar generator 100. In some examples, outriggers 114 are movable between stored and deployed positions. In some embodiments, outriggers 114 can move outward from housing 118, for example, in order to establish a wide, stable base for supporting the mobile solar generator 100. Outriggers 114 can further be configured to extend downward to engage the ground.

As shown in the illustrated example of FIG. 1, in some embodiments, housing 118 can be approximately rectangular in shape and can include four corners. In some such examples the plurality of outriggers 114 can include four outriggers configured to extend away from the housing 118 near a respective one of the four corners. In some examples, the mobile solar generator 100 can include a channel positioned near each of the four corners of the housing 118 and corresponding to a respective one of the four outriggers 114.

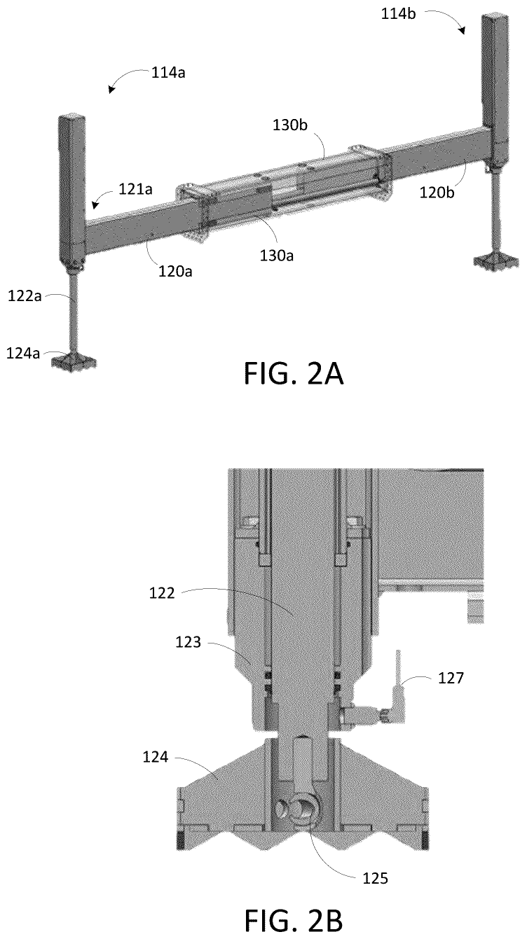

FIG. 2A shows an example outrigger configuration. In the illustrated example, outrigger 114a includes an arm 120a configured to extend outward from the housing, a leg 122a configured to extend downward from a distal end 121a of the arm 120a, and a foot 124a coupled to a bottom surface of the leg 122a. As shown, arm 120a of outrigger 114a extends from a channel 130a, which can be enclosed within housing (e.g., housing 118 of FIG. 1). The example of FIG. 2A shows a second outrigger 114b including an arm 120b that extends from a channel 130b. In some examples, outriggers (e.g., 114a, 114b) include arms (e.g., 120a, 120b) that extend from respective channels (e.g., 130a, 130b). In some embodiments, a single channel can house multiple outriggers, wherein each of such multiple outriggers extend from within a common channel.

FIG. 2B shows a cross-sectional side view of an example outrigger leg and foot. In the example of FIG. 2B, an outrigger (e.g., 114) includes a foot 124 coupled to a bottom surface of a leg 122. In the illustrated example, the leg 122 extends through a channel 123 from which the leg 122 can extend downward. In some examples, the foot 124 can be coupled to a bottom surface of the outrigger leg 122 by a ball joint 125. In some examples, the outrigger includes a proximity sensor 127. In some examples, the proximity sensor is configured to output a signal that represents a position of one or more components. In some examples, the proximity sensor is configured to output a signal representative of a horizontal extension of the outrigger arm. Additionally or alternatively, the proximity sensor can output a signal representative of a proximity of the leg 122 relative to, for example, the arm of the outrigger (e.g., representative of an amount the leg extends downward from arm).

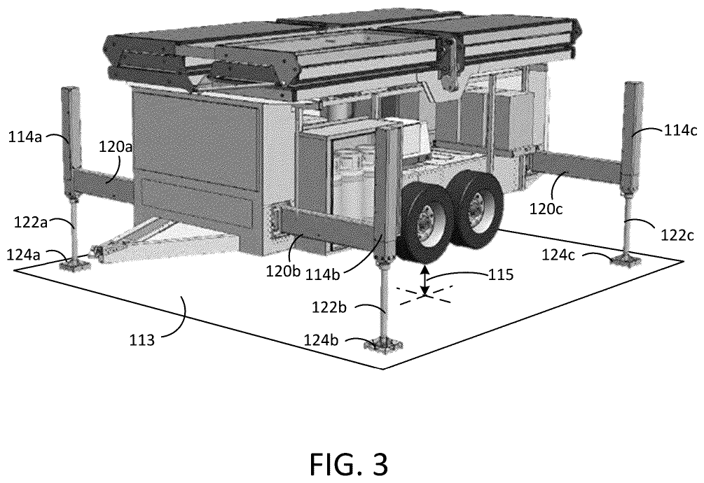

As described, in some embodiments, outriggers can be moved between a stored configuration (such as shown in FIG. 1) to a deployed configuration. FIG. 3 shows an example mobile solar generator comprising outriggers in a deployed configuration. In the example, mobile solar generator 100 includes outriggers 114a-c, each comprising an arm 120a-c extending from a housing 118, a leg 122a-c extending downward from the respective arm 120a-c, and a foot 124a-c coupled to a respective leg 122a-c. Each foot 124a-c engages a ground surface 113.

In some embodiments, moving each of the plurality of outriggers from the stored outrigger configuration to the deployed outrigger configuration can include, for each of the plurality of outriggers, extending an arm of each the outrigger away from the housing and extending a leg of the outrigger downward such that a foot coupled to the bottom surface of the leg contacts a ground surface. Moving each of the plurality of outriggers can include adjusting a height of one or more of the plurality of outriggers in order to level the housing. In some embodiments, the leg(s) of one or more outriggers is extended so that one or more wheels are raised above the ground surface (see, e.g., arrow 115 showing a height that wheels are raised above ground surface 113 in FIG. 3). In some examples, a ball joint coupling each foot to each leg and/or the outriggers raising the wheels off of the ground enable the housing to be leveled even if the ground surface is not itself level or flat.

In some embodiments, outrigger motion can be controlled via hydraulics, for example, to extend outriggers from the housing and/or lower outrigger legs, for example, to raise one or more wheels of the mobile solar generator off of the ground. In some such examples, hydraulic cables can run through one or more housing channels and/or outrigger arms such that the hydraulic cables are hidden from view and protected from being pinched by moving parts. In some embodiments, multiple outriggers (e.g., two of four outriggers, four of four outriggers) can move (e.g., extend away from a housing and/or lower legs) simultaneously. In some examples, outriggers on a first side of a mobile solar generator are configured to move simultaneously and outriggers on a second side of the mobile solar generator are configured to move simultaneously, but at a different time as the outriggers on the first side of the mobile solar generator.

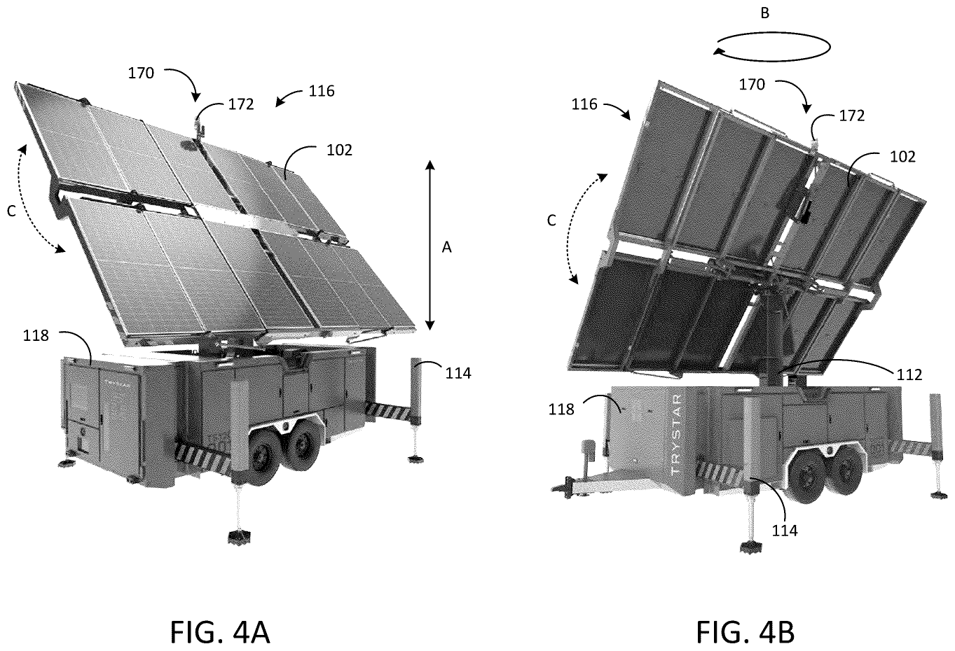

As described elsewhere herein, in some examples, solar array 116 of mobile solar generator 100 comprises can be moved between a stored solar array configuration (e.g., as in FIG. 1) and a deployed solar array configuration. FIGS. 4A-4B show a mobile solar generator 100 comprising a solar array 116 in a deployed solar array configuration. In the illustrated example, the solar array 116 in the deployed solar array configuration comprises twelve solar panels 102. By comparison, in the example of FIG. 1, four solar panels 102 are exposed in the stored solar array configuration. In some examples, a mobile solar generator comprises a solar array configured to move between the stored solar array configuration of FIG. 1, wherein four solar panels are exposed, to the deployed solar array configuration of FIGS. 4A-4B, wherein twelve solar panels are exposed. In some such embodiments, the solar array outputs approximately three times the power in the deployed solar array configuration compared to the stored solar array configuration. In some embodiments, the solar array 116 is configured to output approximately 5.7 kW of power when in the deployed solar array configuration and approximately 1.9 kW of power in the stored solar array configuration. Other numbers of panels in the stored and deployed solar array configurations are possible, and other power output configurations are possible, including other ratios of power provided by a solar array in the stored solar array configuration and the deployed solar array configuration.

The stored configuration and deployed configuration of the solar array can include a variety of dimensions. In some examples, the housing 118 can include a width and a length. The solar array 116 can have a dimension that is wider than the width of the housing 118 when in the deployed solar array configuration (e.g., as shown in FIGS. 4A-4B) but that is not wider than the width of the housing 118 when in the stored solar array configuration (e.g., as shown in FIG. 1). In some examples, the solar array 116 can be completely within a perimeter of the housing 118 while in the stored solar array configuration.

In a further embodiment, when the solar array 116 moves from the deployed solar array configuration to the stored solar array configuration, the solar array 116 can be configured to reduce in size (e.g., by folding, sliding, or other movements as described elsewhere herein) such that the width of the solar array 116 is less than or equal to the width of the housing 118 and is positioned such that the width of the solar array 116 when in the stored solar array configuration fits within the width of the housing 118. This sizing makes transportation of the mobile solar generator easier for a user and can make the device easier to maneuver during transportation.

The mobile solar generator can include ranges of dimensions. In an example embodiment, the width of the housing 118 can be between 8 feet and 9 feet. In some such examples, the width of the housing 118 can be approximately 8.5 feet. In some examples, the length of the housing is between 20 feet and 30 feet, and in some examples, the length of the housing is approximately 26 feet.

In some examples, the width of the solar array 116 in the deployed solar array configuration is between 18 feet and 24 feet and the width of the solar array 116 in the stored solar array configuration is between 8 feet and 9 feet. In some such examples, the width of the solar array 116 in the deployed solar array configuration is approximately 21 feet and the width of the solar array 116 in the stored solar array configuration is approximately 8.5 feet.

While example dimensions are provided, various sizes are possible. For instance, in some embodiments, the mobile solar generator 100 can be designed such that the width of the housing 118 is at or below a maximum width permissible for transportation without being designated a wide or oversized load.

As described elsewhere herein, in various examples, the solar array 116 can include features that allow solar panels 102 to move relative to one another and increase an area exposure to the sun when in the deployed solar array configuration and decrease such exposure when in a stored solar array configuration.

In some embodiments, an adjustable support pillar 112 with multi-axis pivot can adjust the solar array 116 in multiple directions. For example, the adjustable support pillar 112 can raise up and down as illustrated by line “A” while the multi-axis pivot can rotate about its axis as illustrated by line “B” and can tilt the solar array 116 up and down as illustrated by the line “C.” In some examples, the multi-axis pivot is an electromechanical assembly attached to the support pillar 112. In some examples, to deploy the mobile solar generator 100, the adjustable support pillar 112 can raise up (see line “A”) such that the solar array 116 has clearance to rotate about the adjustable support pillar 112 (see line “B”) without hitting other aspects of the mobile solar generator 100. In some examples, the adjustable support pillar 112 is configured to rotate relative to the housing 118 to adjust an orientation of the solar array 116.

In some embodiments, moving the solar array 116 from the deployed solar array configuration to the stored solar array configuration includes rotating the solar array 116 about an axis (e.g., as illustrated by “B” in FIG. 4A) so that the width of the solar array 116 extends in the same direction as the width of the housing 118. In some examples, moving the solar array 116 from the deployed solar array configuration to the stored solar array configuration includes lowering the solar array 116 via the adjustable support pillar 112 (e.g., along line “A” in FIG. 4A). In some examples, moving the solar array 116 to the deployed solar array configuration comprises raising the solar array 116 above the housing 118 via the adjustable support pillar 112 (e.g., along line “A”) and orienting the solar array 116 (e.g., along lines “B” and/or “C”), for example, by rotating the solar array 116 to face the sun as described elsewhere herein.

As illustrated in FIG. 4A, the mobile solar generator 100 can be positioned in a deployed configuration. In some examples, the deployed configuration includes deploying the outriggers 114 to stabilize/level mobile solar generator 100, deploying the solar array 116, adjusting the solar array 116 to maximize solar energy received and electricity generated. In some examples mobile solar generator 100 can configure various components (e.g., one or more batteries, a generator, an inverter, etc.) to store and/or output electrical energy to a load.

In some embodiments, the outriggers 114 can include an electromechanical self-leveling feature to ensure the mobile solar generator 100 is as close to horizontal within a specified amount. The outriggers 114 can be deployed in a plurality of ways including completely manually, partially manually and partially automatically, or completely automatically. For example, the outriggers 114 can be deployed automatically when a user provides input to the mobile solar generator 100 via a user interface such as a touchscreen. The user interface can also include a graphical user interface on a display that can include guided and self-checking deployment of the mobile solar generator.

In addition to the outriggers 114, other portions of the mobile solar generator can be deployed completely manually, partially manually and partially automatically, or completely automatically. For example, after the outriggers 114 are deployed, a person can subsequently engage an auto-deploy feature for deploying the solar array 116 with the adjustable support pillar 112 with multi-axis pivot to a deployed configuration as illustrated in FIGS. 4A-4B. In some examples, the solar array 116 can be moved via one or more hydraulic actuators, one or more electric motors, or a combination thereof.

In some examples, one or more persons can deploy the mobile solar generator 100 within a predetermined time period (e.g., in less than 15 minutes), using none, some, or all automated deployment. For instance, in one example, a user can hit a “deploy” button or other control on a human machine interface (e.g., touchscreen) and the mobile solar generator 100 can automatically deploy the outriggers 114, deploy the solar array from a stores solar array configuration to deployed solar array configuration, adjust the support pillar 112 and multi-axis pivot to orient the solar array 116 toward the sun, and optionally prepare any electronics needed to start generating and providing electrical power.

In some embodiments mobile solar generator includes a controller configured to control operation of one or more mobile solar generator 100 components. In various embodiments, a controller can include one or more processors, such as one or more digital signal processors, microprocessors, field-programmable gate arrays (FPGA), application-specific integrated circuits (ASICs), programmable logic, or other components, operating alone or in combination. In some embodiments, such a controller can include or otherwise be in communication with a memory containing instructions for causing the controller to carry out one or more processes, such as those described herein. In some examples, the mobile solar generator includes a user interface, User interface can include one or more inputs (e.g., a touchscreen, mouse, keyboard, etc.) by which a user can input one or more commands or requests to the controller and one or more outputs (e.g., a display, speaker, etc.) by which the controller can output information to be received by a user.

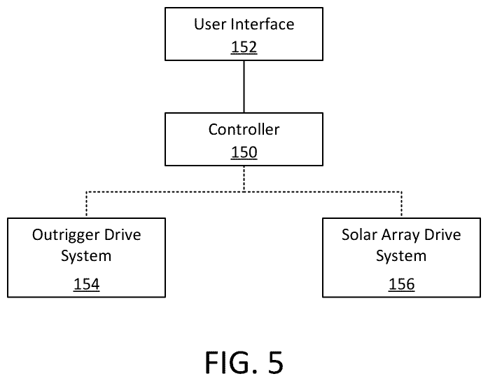

In some embodiments, the mobile solar generator includes a controller configured to control movement of the outriggers. FIG. 5 shows a controller 150 in communication with an outrigger drive system 154 and a solar array drive system 156. The controller 150 can be configured to control movement of the plurality of outriggers to move each of the plurality of outrigger between the stored outrigger configuration and the deployed outrigger configuration, for example, by controlling outrigger drive system 154, which can include, for example, one or more electric motors, hydraulic actuators, such as one or more hydraulic motors or cylinders, and/or other mechanism configured to cause movement of the outrigger(s). Additionally or alternatively, in some examples, the controller 150 can control movement of the solar array to move the solar array between the stored solar array configuration and the deployed solar array configuration, for example, via a solar array drive system 156. In some examples, solar array drive system 156 can include, for example, one or more electric motors, hydraulic actuators, such as one or more hydraulic motors or cylinders, and/or other mechanism configured to cause movement of the solar array. In some embodiments, a solar array comprises two half-arrays, and each of the two half arrays is separately movable between a deployed configuration and a closed configuration via a single hydraulic cylinder.

One or more electrical motors can have a variety of features. In some examples, one or more motors of the mobile solar generator can include a servo motor. For instance, in some embodiments, one or more servo motors can be configured to drive deployment of the solar array via the drive system 156. One or more servo motors can control the movement of the support pillar, the movement of the solar array relative to the support pillar, deployment of the solar array, or combinations thereof. In some such embodiments, the mobile solar generator can be raised, rotated, and/or unfolded using hydraulic cylinders driven by the servo motors.

Some current of the servo motor(s) can be monitored, e.g., using controller 150. For example, in some embodiments, a current monitor can output information to the controller regarding the current of the servo motor. The current monitor can include a current sensor integral with or separate from the servo motor. Such a sensor can be used to monitor a status of the mobile solar generator. For example, greater current drawn by the motor can indicate an increase in resistance to movement of the solar array, as an increase in resistance to movement can lead to increased motor torque and, as a result, an increased current draw.

Thus, in various examples, the amount of current drawn by the servo motor can be a function of the resistance to movement of the component(s) to be moved by the motor actuation. For example, a servo motor can be configured to raise the solar array via the support pillar, and the current drawn by the servo motor is a function of the resistance to raising the solar array. During operation (e.g., deploying solar array), the current drawn by the associated servo motor(s) can have an expected range, such as a maximum current value associated with a given operation (e.g., raising the solar array, expanding the solar array). Current values outside of the expected range (e.g., above a threshold value) can indicate excess resistance to the motion the servo motor is attempting to achieve (e.g., raising and/or expanding a solar array), such as due to a physical obstruction to the desired motion (e.g., a tree or other obstacle impeding the solar array from raising and/or expanding).

In some embodiments, the controller is configured to receive information regarding the current being drawn by one or more servo motors associated with movement of one or more components. The controller can be programmed with a predetermined current threshold for each of the servo motors. Different motors can have the same or different current thresholds associated therewith. The controller can be configured to compare the current associated with each motor to the corresponding threshold.

In some embodiments, when increased current greater than the predetermined current threshold is detected, the mobile solar generator can act to stop movement of at least the component facing the increased resistance, for example, by stopping providing power to the motor whose corresponding current exceeds a threshold. In some embodiments, if the current for any one motor exceeds at threshold, the controller is configured to stop motion of all motors associated with the motion in progress (e.g., deploying or collapsing the solar array, moving one or more outriggers, etc.).

In some embodiments, one or more motor(s) can act in combination with one or more hydraulic fluid lines to control movement of system components. For example, movement of the outriggers can be controlled via hydraulic fluid lines. The hydraulic fluid lines can be used to control movement of the outriggers during deployment and solar tracking. Various valves can be integrated into the hydraulic fluid lines, including, for example, one or more check valves. The check valves can be one-way valves and regulate fluid flow in the hydraulic lines such that flow is only permitted to flow one way through the valve(s) in the hydraulic fluid line.

In some such examples, if pressure is lost within a hydraulic fluid line having a check valve (e.g., due to a leak or other equipment failure), the check valves can mitigate the loss of pressure throughout the hydraulic line by preventing some hydraulic fluid from flowing backwards through the check valve to the location of a leak in the line. For example, if pressure decreases at a location in the hydraulic line, a check flow valve can maintain pressure at other locations along the hydraulic line. Lines carrying hydraulic fluid can include check valves. The check flow valve can prevent rearward flow of the hydraulic fluid at a location in the hydraulic line.

Maintaining pressure of the hydraulic fluid in the hydraulic line can prevent unwanted or uncontrolled movement or motion of components whose movement is controlled by the hydraulic line. For example, if the hydraulic line fails and pressure within the hydraulic line is not be maintained, uncontrolled movement and/or collapse of one or more components whose motion is controlled using such a hydraulic line, such as an outrigger or solar array. Unexpected or sudden movement of an outrigger or solar array can cause damage to the mobile solar generator, such as the outrigger(s) and/or solar array. Such movement can also cause injury or damage in the vicinity of the mobile solar generator. Check valves in the hydraulic lines help maintain pressure in hydraulic lines even in the event of fluid leaks or other equipment damage, and can prevent and/or reduce the risk of such an event.

FIG. 5 further includes a user interface 152 in communication with the controller 150. In some examples, in response to one or more commands received from the user interface 152, the controller 150 can cause each of the plurality of outriggers to move from the stored outrigger configuration to the deployed outrigger configuration via the outrigger drive system 154 and cause the solar array to move from the stored solar array configuration to the deployed solar array configuration via the solar array drive system 156.

A controller can be used to manipulate each of the outriggers into different configurations. For example, a controller can be configured to extend each of the four outriggers (e.g., 114a-c) away from the housing (e.g., 118) by extending the arm (e.g., 120a-c) of each of the outriggers (e.g., 114a-c) out of the respective channel in the housing (e.g., 118). This movement can facilitate the deployment of the outriggers.

Each of the plurality of outriggers can be configured to move between a stored outrigger configuration and a deployed outrigger configuration such as the configurations described herein. For example, in some embodiments, in the deployed outrigger configuration, the foot of the outrigger can extend to touch a ground surface, and in some cases, the controller can be configured to determine a level of the housing of the mobile solar generator and control the outriggers (e.g., by controlling one or more outrigger legs) to level the housing.

The housing can undergo changes in configuration throughout the deployment process. In some embodiments, moving each of the plurality of outriggers from the stored outrigger configuration to the deployed outrigger configuration can include raising the housing of the mobile solar generator such that each of the at least four wheels is raised off of the ground surface. In some examples, moving each of the plurality of outriggers from the stored outrigger configuration to the deployed outrigger configuration can include raising the housing of the mobile solar generator such that at least one of the plurality of wheels is raised off of the ground surface.

In some embodiments, each of the plurality of outriggers is further configured to move to an outrigger lift configuration in which the foot touches the ground surface, but no other component of the mobile solar generator touches the ground surface. In some embodiments, the deployed outrigger configuration comprises the outrigger lift configuration. In other embodiments, an outrigger lift configuration is different from the deployed outrigger configuration. For example, in some embodiments, the arm of each of the plurality of outriggers is configured to extend outward from the housing by a deployed distance in the deployed outrigger configuration, and in some such examples, moving the plurality of outriggers to the deployed outrigger configuration comprises extending the arm of each of the plurality of outriggers outward from the housing by the deployed distance. In some examples, the arm of each of the plurality of outriggers is configured to extend outward from the housing by a lift distance in the outrigger lift configuration, the lift distance being less than the deployed distance. In some such examples, moving the plurality of outriggers to the outrigger lift configuration comprises extending the arm of each of the plurality of outriggers outward from the housing by the lift distance.

In some examples, the controller is further configured to cause the plurality of outriggers to move to the outrigger lift configuration without adjusting the height of the adjustable support pillar or adjusting the orientation of the solar array relative to the adjustable support pillar.

In some embodiments, the outriggers can be used to bear some weight of the mobile solar generator, but not necessarily raise, for example, the wheels of the mobile solar generator fully off of the ground. For instance, in some embodiments, each of the plurality of outriggers is further configured to move to an outrigger partial lift configuration in which the foot of the outrigger touches the ground surface and wherein the plurality of wheels also touch the ground surface. In some such examples, plurality of wheels bear less of the weight of the mobile solar generator when the plurality of outriggers is in the outrigger partial lift configuration than when the plurality of outriggers is in the stored outrigger configuration.

As described, in some embodiments, moving each of the plurality of outriggers from the stored outrigger configuration to the deployed outrigger configuration can include leveling the housing via the plurality of outriggers. In some cases, the controller controls deployment of the outriggers such that the mobile solar generator can be self-leveling. In various examples, self-leveling movement can occur in different ways. For example, in some embodiments, the self-leveling movement can occur as each of the plurality of outriggers move simultaneously (e.g., wherein the legs of each of the outriggers move at the same time). In other embodiments, each of the legs of each of the outriggers can move individually and incrementally to self-level the housing.

Similar to the outriggers described above, in some embodiments, the controller can be configured to control deployment of the outriggers 114 and the solar array 116, for example, in response to a command received from a user interface. For instance, in some examples, the controller can be configured to cause each of the plurality of outriggers to move from the stored outrigger configuration to the deployed outrigger configuration in response to a first command received from the user interface. In some such examples, after causing each of the plurality of outriggers to move from the stored outrigger configuration to the deployed outrigger configuration, the controller can be configured to cause the solar array to move from the stored solar array configuration to the deployed solar array configuration in response to a second command received from the user interface. Thus, in some examples, the controller can be configured to cause each of the plurality of outriggers to move from the stored outrigger configuration to the deployed outrigger configuration before causing the solar array to move from the stored solar array configuration to the deployed solar array configuration.

The mobile solar generator can include additional components that interact with the outriggers. In some embodiments, the mobile solar generator can include a plurality of outrigger sensors corresponding to one of the plurality of outriggers. The plurality of outrigger sensors can be in communication with the controller and configured to output outrigger position information representative of a position of the arm and/or a position of the leg of the corresponding outrigger. Such sensor(s) can be used, for example, to determine a status of outriggers.

Additionally or alternatively, in some examples, the mobile solar generator can include a plurality of sensors in communication with the controller and configured to detect a position of the solar array when the solar array moves from the deployed solar array configuration to the stored solar array configuration. In some examples, the controller can be configured to output an alert (e.g., via a user interface) based on information provided by the plurality of sensors if the solar array deviates from an expected stored solar array configuration.

The controller can also include variety of safety checks. In some embodiments, the controller can be configured to, after causing each of the plurality of outriggers to move from the stored outrigger configuration to the deployed outrigger configuration and before causing the solar array to move from the stored solar array configuration to the deployed solar array configuration, present one or more safety checks via the user interface.

The safety checks can affect the deployment of the solar array. In some examples, the controller is configured to not cause the solar array to move from the stored solar array configuration to the deployed solar array configuration unless the controller receives, via the user interface, an acknowledgement of the one or more safety checks presented via the user interface. The controller can require acknowledgement of the one or more safety checks, for example, to allow a user to confirm, for example, that there is sufficient space to deploy the solar array and/or that there are no obstacles in the way that would interfere with deploying the solar array.

Multiple safety checks can be presented. For instance, in some embodiments, the one or more safety checks can include a plurality of safety checks. The controller can be configured to present each of the plurality of safety checks via the user interface. The controller can be configured to cause the solar array to move from the stored solar array configuration to the deployed solar array configuration only if the controller receives, via the user interface, a separate acknowledgement for each of the plurality of safety checks presented via the user interface.

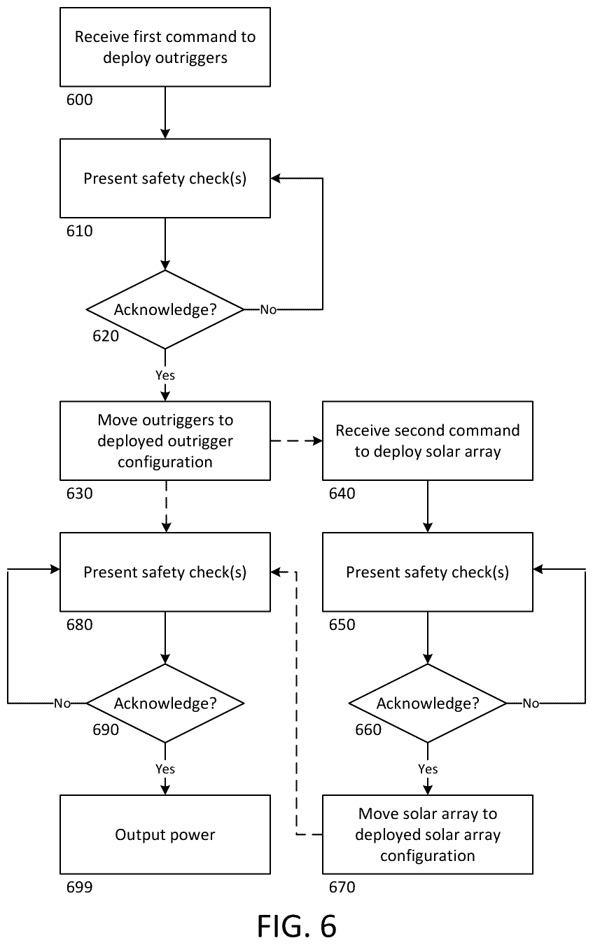

In some examples, the controller can be configured to present safety checks in response to certain commands, such as received via the user interface. FIG. 6 shows an example process flow diagram showing an example process for deploying outriggers and a solar array requiring one or more safety checks. In some examples, the process can be carried out by the mobile solar generator controller. In the example embodiment, the process includes receiving a first command from the user interface to move the outriggers to the deployed outrigger configuration 600, for example, via a user interface. After receiving the first command, the process includes presenting one or more safety checks 610, e.g., via the user interface. Example safety checks can include ensuring that: the mobile solar generator is on level ground, the mobile solar generator is within a range of a load or input power source, the mobile solar generator is disconnected from a tow vehicle, the two vehicle is moved away from the mobile solar generator, tire chocks are positioned near wheels of the mobile solar generator, there is sufficient clearance around the mobile solar generator, safety cones are positioned around the mobile solar generator, and that cabinet doors or other storage compartments of the mobile solar generator are closed.

If the safety check(s) are acknowledged (620), e.g., via a user input via the user interface, the process includes moving the outriggers to the deployed outrigger configuration 630. For example, the controller can be configured to cause each of the plurality of outriggers to move from the stored outrigger configuration to the deployed outrigger configuration in response to the first command only after receiving the acknowledgement of the one or more safety checks. In some examples, one or more additional safety checks can be performed within stages of an outrigger deployment process, for example, to ensure that foot pads are placed under the outrigger feet after extending outrigger arms but before lowering outrigger legs.

In some embodiments, after deploying the outriggers, the process includes receiving a second command from the user interface to move the solar array to the deployed solar array configuration 640, for example, via a user interface. After receiving the second command, the process includes presenting one or more safety checks 650, e.g., via the user interface. In some examples, such safety checks can ensure that there is sufficient clearance to deploy the solar array around the mobile solar generator and ensuring that wind speeds are below a threshold level. If the safety check(s) are acknowledged (660), e.g., via a user input via the user interface, the process includes moving the solar array to the deployed solar array configuration 670. For example, the controller can be configured to cause the solar array to move to the deployed solar array configuration in response to the second command only after receiving the acknowledgement of the one or more safety checks.

In some examples, in addition to one or more safety checks as described above, the controller only moves the solar array to the deployed solar array configuration if the outriggers have been first moved to the deployed outrigger configuration. In some examples, while various steps in FIG. 6 are shown separately and linearly, in some examples, various steps can be performed partially before the process includes presenting one or more additional safety checks. For instance, in an example, while moving the outriggers to a deployed outrigger configuration (630), the outrigger can extend outrigger arms away from a housing, but not extend the outrigger legs toward the ground until one or more additional safety checks are acknowledged. Various additional safety checks are possible.

In various embodiments, similar safety checks are used when moving the outriggers from the deployed outrigger configuration to the stored outrigger configuration, and/or when moving the solar array from the deployed solar array configuration to the stored solar array configuration. In an example embodiment, the controller can be configured to cause the solar array to move from the deployed solar array configuration to the stored solar array configuration in response to a command received from the user interface. The controller can be configured to, after the solar array is in the stored solar array configuration, present one or more safety checks via the user interface and receive an acknowledgement of the presented one or more safety checks. The controller can be configured to, after receiving the acknowledgement, cause each of the plurality of outriggers to move from the deployed outrigger configuration to the stored outrigger configuration.

In some examples, one or more aspects of the deployment of the outriggers and/or solar array are performed automatically, for example, by the controller (e.g., 150) interfacing with an outrigger drive system (e.g., 154) and/or a solar array drive system (e.g., 156). For instance, in some embodiments, moving each of the plurality of outriggers from the stored outrigger configuration to the deployed outrigger configuration and the moving the solar array from the stored solar array configuration to the deployed solar array configuration include a plurality of automated steps. In some examples, the plurality of automated steps can include at least two automated steps separated by a confirmation step. The confirmation step can include outputting a safety check after a first of the at least two automated steps. In some examples, the mobile solar generator does not proceed to the second of the at least two automated steps until receiving an acknowledgement of the safety check. In some examples, the aggregate time it takes to complete the plurality of automated steps associated with moving each of the plurality of outriggers to the deployed outrigger configuration and moving the solar array to the deployed solar array configuration is under 15 minutes. In some such examples, the aggregate time it takes to complete the plurality of automated steps can be under 10 minutes.

Because some example processes require manual interaction (e.g., acknowledging one or more safety checks via a user interface), the total deployment time may depend on the responsiveness of a user acknowledging the safety checks. However, the automated steps independent of a time spent waiting for a user to acknowledge the safety checks can be under 15 minutes, and in some examples, under 10 minutes.

Continuing with the process of FIG. 6, in some embodiments, after deploying both the outriggers and the solar array (or, in some examples, after deploying only the outriggers), one or more additional safety checks can be presented 680. Example safety checks can include ensuring that: cables of loads are connected, cables are straight and not tangled, and that a door proximate cable receptacles is closed and locked. If such safety check(s) are acknowledged (690), the process can further include output power 699 from the mobile solar generator. Thus, in some examples, the mobile solar generator does not output live power unless one or more safety checks are acknowledged (690). In various examples, such safety checks can be performed after deploying the outriggers or after deploying both the outriggers and the solar array. In other examples, a process can initiate at steps 680 without deploying either the outriggers or the solar array, wherein, if one or more safety checks are acknowledged (e.g., 690), the mobile solar generator can output power, for example, while in a stored configuration.

In some embodiments, a process such as that shown in FIG. 6 is initiated in response to a “deploy” or “output power” command received at a user interface. For instance, in some examples, after an initial deploy command is received, the process of FIG. 6 proceeds without a separate command to deploy the solar array. Instead, in some examples, deploying the outriggers and the solar array are performed automatically in response to a single “deploy” or similar command. However, as described, in some such examples, deployment is not performed and/or completed without one or more safety checks and acknowledgements before and/or during the deployment process.

In addition or as an alternative to the one or more safety checks discussed above, in some examples, a mobile solar generator includes one or more alarms (e.g., lights, bells, speakers, etc.) to alert those nearby of upcoming movement of one or more aspects of the mobile solar generator. For instance, in some examples, a mobile solar generator includes one or more lights that can illuminate and/or speakers that can output a sound prior to and/or while outriggers and/or solar array is moved between configurations (e.g., between stored and deployed configurations).

As described elsewhere herein, in some embodiments, solar array (e.g., 116 in FIG. 1) is movable relative to the housing (e.g., 118) of the mobile solar generator (e.g., 100). In some examples, the mobile solar generator is configured such that the solar array moves to track the sun. Various embodiments can include a variety of features that can be used to move the solar array 116. In some embodiments, mobile solar generator 100 can include a housing 118, an adjustable support pillar 112 coupled to the housing 118 and configured to extend upward from the housing 118, a solar array 116, and a multi-axis pivot connecting the solar array 116 to the adjustable support pillar 112. In some examples, a height of the solar array 116 can be adjustable via the adjustable support pillar 112. The solar array 116 can be configured to move about at least two axes relative to the adjustable support pillar 112. In some embodiments, the solar array 116 can be configured to tilt about a first axis of rotation, shown by C in FIG. 4A. Additionally or alternatively, in some embodiments, the solar array 116 can rotate about a second axis of rotation, shown by B in FIG. 4A. In some embodiments, the solar array is configured to tilt about the first axis of rotation to elevation angles between 0° and 50°. In some embodiments, the solar array is configured to rotate about the second axis of rotation to ±175° from a neutral position.

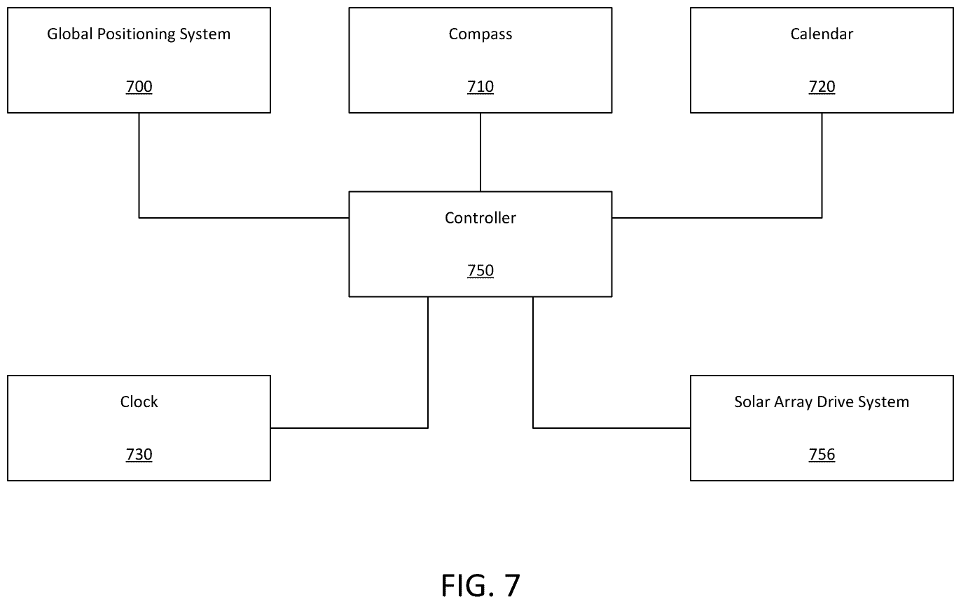

Movement of the solar array can be facilitated using a variety of components. FIG. 7 shows a schematic system diagram showing various components of a mobile solar generator, one or more of which can be used in connection with moving the solar array to track the sun. In the illustrated embodiment, a mobile solar generator includes a solar array drive system 756. In some examples, solar array drive system 756 comprises one or more components in common with solar array drive system 156 of FIG. 5 for moving the solar array between the stored solar array configuration and the deployed solar array configuration.

In some examples, the solar array drive system 756 can include one or more electromechanical components. In some embodiments, the solar array drive system 756 can include one or more hydraulic actuators, electric motors, or other types of motors or actuators configured to cause movement of the solar array. In some examples, solar array drive system 756 includes one or more electric motors configured to cause rotation of the solar array about one or more axes (e.g., along lines B and C in FIGS. 4A and 4B). Additionally or alternatively, in some examples, solar array drive system 756 can include one or more hydraulic cylinders configured to control a height of the solar array (e.g., via adjustable support pillar). Various drive mechanisms can be used.

The solar array drive system 756 can be configured to move the solar array (e.g., 116) about each of the at least two axes of rotation relative to the adjustable support pillar (e.g., 112) (e.g., as shown by “B” and “C” in FIG. 4A). In some examples, the drive system 756 comprises one or more electrical motors configured to move the solar array about each of the at least two axes of rotation.

Because the mobile solar generator is mobile, the position of the sun relative to the generator can change depending on the location of the generator. For example, as the generator is moved north or south, the elevation angle of the sun relative to the generator can be different for a given time of a given day. Additionally, the facing direction of the generator can be different each time the generator is used, for example, when the generator is brought to a location for operation. Thus, in some cases, the global position and/or facing direction of the mobile solar generator may vary from use to use.

Accordingly, in various embodiments, the generator can include components and features to accommodate for use in various locations. In some embodiments, a controller 750 can be configured to cause the solar array drive system 756 to move a solar array (e.g., 116) to track the sun. In some such embodiments, the controller 750 can be configured to determine a motion path for the solar array to track the sun and/or periodically calculate a new facing direction in order to move the solar array to face the sun.

In some embodiments, mobile solar generator can include a compass 710, such as a digital compass, and a global positioning system (GPS) 700. The controller 750 can be configured to receive position information from the GPS 700, receive direction information from the compass 710, and determine the motion path for the solar array to track the sun based on the position information and the direction information.

In some embodiments, the mobile solar generator can include one or more time-telling components for tracking the sun. For instance, in some embodiments, the mobile solar generator can include a clock 730 and a calendar 720. The controller 750 can be configured to receive time-of-day information from the clock 730, receive date information from the calendar 720, and use the time-of-day information and date information when tracking the sun. In some embodiments, the controller is configured to periodically update an orientation of the solar array to move the solar array, for example, along the motion path based on the time-of-day information and the date information. In some examples, the time-telling components can be used in combination with the positioning components to track the sun.

In some embodiments, the controller 750 can be configured to receive information from one or more components, such as the GPS 700, compass 710, calendar 720, and/or clock 730 and cause the solar array drive system to move the solar array based on the received information. In some examples, controller 750 can be configured to perform functions described with respect to controller 150 in FIG. 5. For instance, in some examples, a mobile solar generator includes a single controller configured to control solar array and outrigger deployment as well as move the solar array to track the sun.

In some examples, some or all of such information can be used to determine movement of the solar array to track the sun. In some examples, a method related to such movement can include tilting the solar array about a first axis of rotation relative to the adjustable support pillar (e.g., as shown in “C” in FIG. 4A) and rotating the solar array about a second axis of rotation relative to the adjustable support pillar (e.g., as shown in “B” in FIG. 4A) to position the solar array in a first orientation. The first orientation can be based on, for example, the facing direction of the mobile solar generator. The method can include tilting the solar array about the first axis of rotation relative to the adjustable support pillar and rotating the solar array about the second axis of rotation relative to the adjustable support pillar to position the solar array in a second orientation different from the first. The path from the first orientation to the second orientation can follow the path of the sun.

In some examples, the method can include using location information to determine the movement of the solar array. In some embodiments, the method includes determining a coordinate position of the mobile solar generator based on information received from a global positioning system (GPS). In some embodiments, the method can include determining a motion path for the solar array to track motion of the sun based on the facing direction and the coordinate position. The motion path can include a plurality of orientations of the solar array. For example, in some embodiments, a GPS position and facing direction provide information such that a relative position of the sun can be predicted for a given time and date.

The method can include using time information, such as the date and/or time of day to determine the movement of the solar array. In some embodiments, the method can include determining a date based on information received from a calendar 720. In some examples, determining the motion path for the solar array to track the sun is further based on the date. In some examples, the motion path comprises a relationship between a time of day and a relative position of the sun based on a date, coordinate location, and facing direction.

In some cases, moving the solar array can be based on the time of day. In some embodiments, the method can include determining a time of day based on information received from a clock 730. The method can include moving the solar array to a predetermined orientation along the motion path based on the time of day. In some examples, time of day and/or date information can be used in combination with the location information.

The method can include moving the solar array in various orientations. In some embodiments, the method can include adjusting an orientation of the solar array to each of the plurality of orientations along the motion path by tilting the solar array about the first axis of rotation relative to the adjustable support pillar and rotating the solar array about the second axis of rotation relative to the adjustable support pillar. The plurality of orientations can include the first orientation and the second orientation.

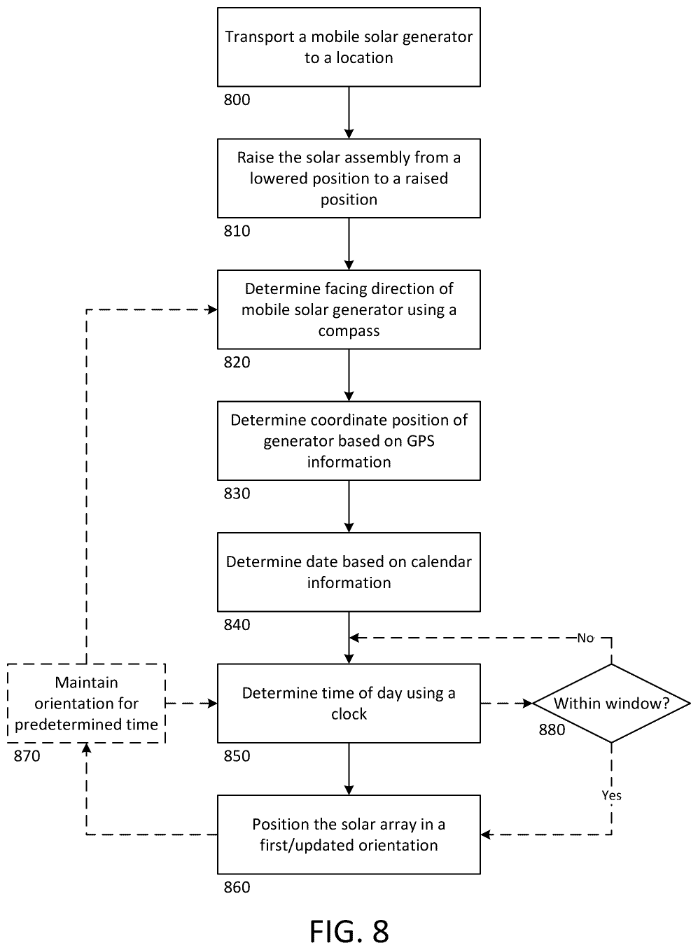

FIG. 8 shows an example process flow diagram showing a method for tracking the sun by a mobile solar generator. The process of FIG. 8 includes transporting a mobile solar generator to a location 800. The mobile solar generator can include various features described herein. The process further includes raising the solar array vertically from a lowered position to a raised position via the adjustable support pillar 810.

In the example of FIG. 8, the process includes determining a facing direction of the mobile solar generator based on information received from a compass 820, determining a coordinate position of the mobile solar generator based on GPS information 830, determining a date based on calendar information 840 and determining a time of day using a clock 850. The process further includes positioning the solar array in a first or updated orientation 860. In some examples, the positioning the solar array in the first or updated orientation 860 is based on one or more of the determined parameters, such as a facing direction, coordinate position, date, and/or time.

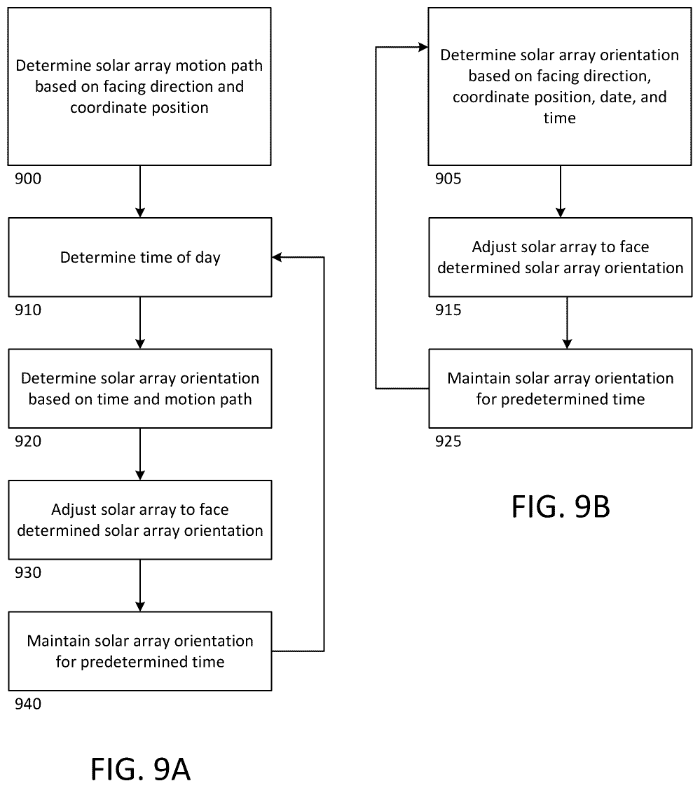

In some embodiments, positioning the solar array in an orientation comprises positioning the solar array in an orientation based on a predetermined motion path. FIG. 9A shows an example process flow diagram illustrating an example method for positioning a solar array in a first or updated position. The process of FIG. 9A comprises determining solar array motion path based on a facing direction and coordinate position of a mobile solar generator 900. In some examples, determining the motion path is further based on a date (e.g., as determined via a calendar). As described herein, in some embodiments, a controller can determine a motion path 900 using the facing direction, coordinate position, and date, for example, wherein the motion path associates times of day with a solar array orientation. In some embodiments, determining the motion path can be performed, for example, via a controller in communication with one or more components configured to provide such information, such as a compass, calendar, GPS, and/or user interface from which the controller can receive data. With reference to FIG. 8, in some examples, the step of determining a solar array motion path (900) can be performed after step 840 of FIG. 8.

The process of FIG. 9A further includes determining a time of day 910 (e.g., via a clock) and determining an orientation based on the time of day and motion path 920. The process includes positioning the solar array in the determined orientation 930, maintaining the solar array orientation for a predetermined time 940, and, after the predetermined time, the process in the illustrated example reverts to determining a time of day 910 and determining an orientation based on the time of day and motion path 920 and positioning the solar array in the determined orientation 930.

In some such examples, a controller can be configured to periodically determine a desired solar array orientation based on a calculated motion path and update the orientation of the array to face a determined orientation. In some embodiments, for instance, when updating a solar array orientation according to a calculated motion path, determining a time of day (e.g., as in step 910), can include receiving information from a clock representing a time of day. Additionally or alternatively, in some examples, determining a time of day includes determining a relative time of day compared to a previously determined time of day. For instance, in some examples, a controller can determine that, since a previous adjusting of a solar array to face a determined orientation, a predetermined amount of time has passed (e.g., the predetermined time of step 940), and can use such information to determine an updated solar array orientation.

In some examples, a desired orientation can be calculated each time the orientation is to be updated. FIG. 9B shows an alternate example process diagram for positioning the solar array in an orientation. The illustrated example comprises determining a solar array orientation based on a facing direction, coordinate position, date, and time of day 905. As described elsewhere herein, in some examples, a controller can receive such information from a compass, GPS, calendar, clock, or user interface.

The process of FIG. 9B further includes adjusting the solar array to face the determined array orientation 915 and maintaining the solar array orientation for a predetermined time 925. After the predetermined time, the process repeats to determine a new solar array orientation (905) and adjust the solar array to face the determined orientation 915. In some embodiments, determining a solar array orientation according to step 905 can be performed after step 850 in FIG. 8.

In various embodiments, as described herein, a controller can be configured to adjust a solar array orientation via a solar array drive system by which the controller can adjust the solar array to face a desired orientation.

In some cases, moving the solar array to track the position of the sun increases an amount of power that can be generated by the solar array compared to a stationary array. However, the process of moving the array can consume energy. In some examples, adjusting an orientation of the solar array in the method can occur periodically, for example, a predetermined frequency. In some embodiments, adjusting the orientation of the solar array to each of a plurality of orientations along a determined motion path can include adjusting the orientation of the solar array at a predetermined frequency. In some examples, adjusting the orientation of the solar array at a predetermined frequency can include adjusting the orientation of the solar array at a rate of between once every 10 minutes and once every 60 minutes.

In some embodiments, periodic update of the orientation of the solar array comprises periodically determining a solar array orientation, for example, such as freshly calculating a preferred solar array orientation at predetermined intervals. In some embodiments of the mobile solar generator 100, periodically updating the orientation of the solar array 116 can include, at predetermined intervals, determining an updated preferred orientation of the solar array 116 based on the position information, the direction information, the time-of-day information, and the date information, and adjusting the orientation of the solar array 116 to the updated preferred orientation via the solar array drive system (e.g., 756). In some embodiments, the controller can be configured to determine and move the solar array to an updated orientation at a rate of between once every 10 minutes and once every 60 minutes.

Additionally or alternatively, in some cases, added power generation benefits gained from tracking the sun diminish at times when the sun is low on the horizon, such as during sunrise or sunset. In some embodiments, the controller of the mobile solar generator can be configured to determine if the time of day (e.g., based on information received from a clock) is within a predetermined window of time. In some such embodiments, the controller is configured to periodically update the orientation of the solar array (e.g., by freshly calculating a new desired orientation or moving the array along a predetermined motion path) only if the time of day is within the predetermined window of time.

For example, in some embodiments, the process of FIG. 8 includes, after determining a time of day, determining whether the time of day is within a predetermined window 880. The predetermined window can be based on, for example, the date (e.g., from a calendar) and/or location (e.g., from a GPS), since sunrise and sunset times can vary based on the time of year and location. In the example embodiment, if the time is not within the predetermined window, the process continues to determine the time of day, for example, until the time of day is within the window in step 880. However, if the time is within the predetermined window during which tracking is to occur, the process proceeds to positioning the solar array in a first or updated orientation 860.

As described elsewhere herein, in some embodiments, updating the orientation of the solar array can occur at different times and in varying frequencies. In the process of FIG. 8, after positioning a solar array in a first/updated orientation 860, in some embodiments, the orientation can be maintained for a predetermined period of time. In some embodiments, as descried herein, adjusting the orientation of the solar array at a predetermined frequency can include adjusting the orientation of the solar array at a rate of between once every 10 minutes and once every 60 minutes. Accordingly, maintaining the orientation for a predetermined time (e.g., at steps 870, 940, and 925, in FIGS. 8, 9A, and 9B, respectively) can include maintaining an orientation for a period of time between 10 minutes and 60 minutes. In the example of FIG. 8, after maintaining the orientation for a period of time, the process can continue with determining a new orientation for the solar array, for example, by newly calculating a preferred orientation or by moving the solar array to a new position on a calculated motion path such as described herein. For instance, in an example, after maintaining the orientation for a predetermined time, the process of FIG. 8 can include re-determining several parameters that can be used to calculate a new preferred orientation. In another example, after maintaining the orientation for a predetermined time, the process of FIG. 8 can include update a solar array orientation only based on an updated determined time (e.g., to update an orientation along a determined motion path).

As described, in some embodiments, the mobile solar generator uses information from various components, such as a compass, GPS, clock, and calendar, to determine an orientation of the solar array to track the sun. In some cases, the mobile solar generator does not use irradiance as an input to solar tracking, as moving the solar array based on irradiance information can require additional energy consumption in order to move the solar array through enough candidate orientations to determine a preferred orientation based on the irradiance.

As described elsewhere herein, in some embodiments, mobile solar generator 100 includes one or more batteries that can store power generated by the solar panels 102 of the solar array 116. In some examples, such one or more batteries can be stored in one or more battery compartments of the mobile solar generator, for example, within the housing of the mobile solar generator. Battery compartments can include one or more batteries included therein.

Any variety of batteries can be used. In some examples, batteries comprise lithium batteries. In some examples, the batteries are LiFePO₄ batteries. In some embodiments, the one or more batteries are configured to produce an output voltage of between 30 V and 60 V. In some such embodiments, the one or more batteries are configured to produce an output voltage of 48 V. Other possible voltage arrangements are possible. For example, an output voltage can be up to 1000V or 2000 V. In some embodiments, an output voltage can be selected to be within an operating voltage range of one or more system components, such as one or more inverters. In some embodiments, the output voltage comprises a voltage made up of a plurality of batteries, each having a lower voltage than the output voltage, arranged in series to achieve an output voltage. In various embodiments, individual batteries can be arranged in series, parallel, or combinations of series and parallel. In various embodiments, the batteries have a total charge capacity of between 60 kWh and 180 kWh.

In some examples, one or more batteries can be within the housing of the mobile solar generator, for example, in an enclosure that is easily accessible for permitting access to the enclosure, for example, for replacing or otherwise servicing the one or more batteries. In some examples, the one or more batteries are enclosed in an environmentally controlled compartment that can regulate environmental conditions for the batteries (e.g., temperature, humidity). The mobile solar generator can also include a fire suppression system for the batteries which can be integrated into a battery compartment.

In some embodiments, a battery compartment is accessible from a bottom surface of a housing of a mobile solar generator. In some such examples, for each of one or more battery compartments, the mobile solar generator includes one or more battery compartment access panels configured to cover the battery compartment from outside of the housing. Battery compartment access panels can be movable to permit access from the outside of the housing into the battery compartment. In some examples, the battery compartment access panels are positioned on a bottom side of the housing, and a corresponding battery compartment is accessible from a bottom side of the housing when the battery compartment access panels are removed.

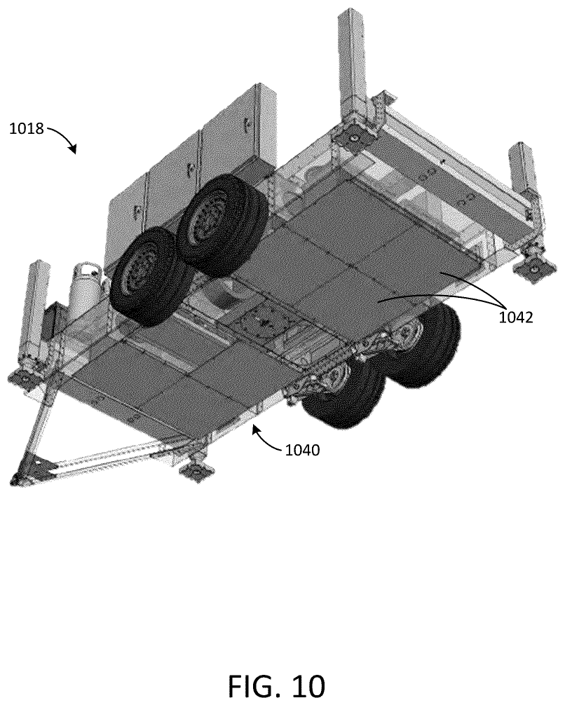

FIG. 10 shows a bottom perspective view of a portion of an example mobile solar generator. In the illustrated example, a bottom surface 1040 of a housing 1018 includes a plurality of battery compartment access panels 1042. In some examples, a battery compartment access panel (e.g., 1042) can be removed to reveal an opening in the bottom surface 1040 of the housing 1018 and provide access to one or more batteries stored in one or more battery compartments. In various examples, removing the battery compartment access panel 1042 comprises opening a door (e.g., sliding, swinging, folding, etc.) that remains partially attached to the housing. In other examples, removing the battery compartment access panel 1042 comprises fully detaching the panel 1042 from the housing 1018.

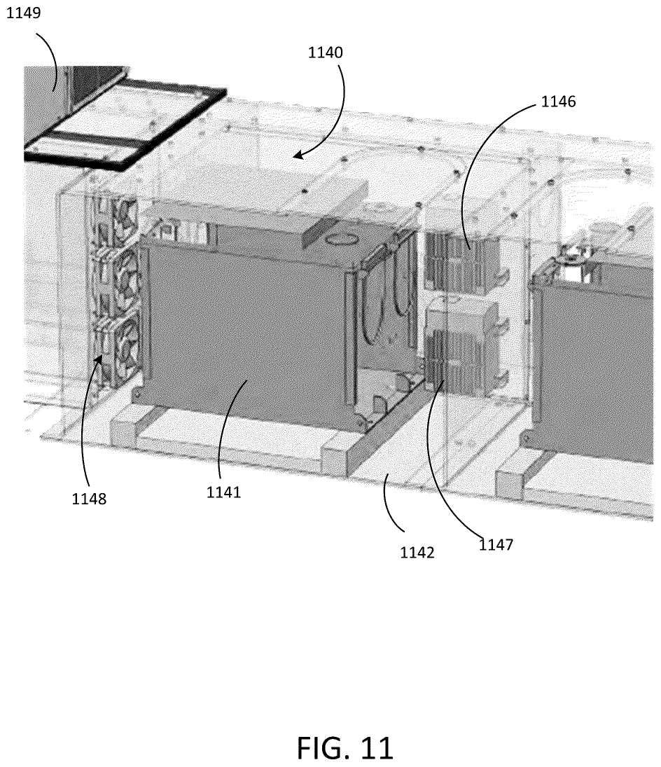

As described, in some embodiments, a mobile solar generator includes an environmentally controlled compartment. FIG. 11 shows an example battery compartment within a mobile solar generator housing including climate control components. In the illustrated example, battery compartment 1140 houses a battery 1141 and comprises heaters 1146, 1147 configured to heat the battery compartment 1140. Example heaters 1146, 1147 can be electrically powered heaters.

The battery compartment 1140 of FIG. 11 further includes a plurality of fans 1148 positioned proximate the battery 1141. In some examples, the fans 1148 are configured to cause air to flow through the battery compartment 1140. For example, fans 1148 can be configured to blow conditioned air to the battery compartment 1140. In some examples, battery compartment 1140 comprises one or more vents to permit air to exit the battery compartment 1140 as fans 1148 blow air into the battery compartment 1140.

In some embodiments, a mobile solar generator includes one or more chillers 1149 proximate a battery compartment 1140 configured to condition air for flowing through the battery compartment. Chiller 1149 can include, for example, a refrigerant circuit configured to condition air. In some examples, a refrigerant circuit is part of a phase-change refrigeration system. In the illustrated example, fans 1148 are configured to blow air conditioned by chiller 1149 into the battery compartment 1140. In some examples, a liquid cooling system can be used.

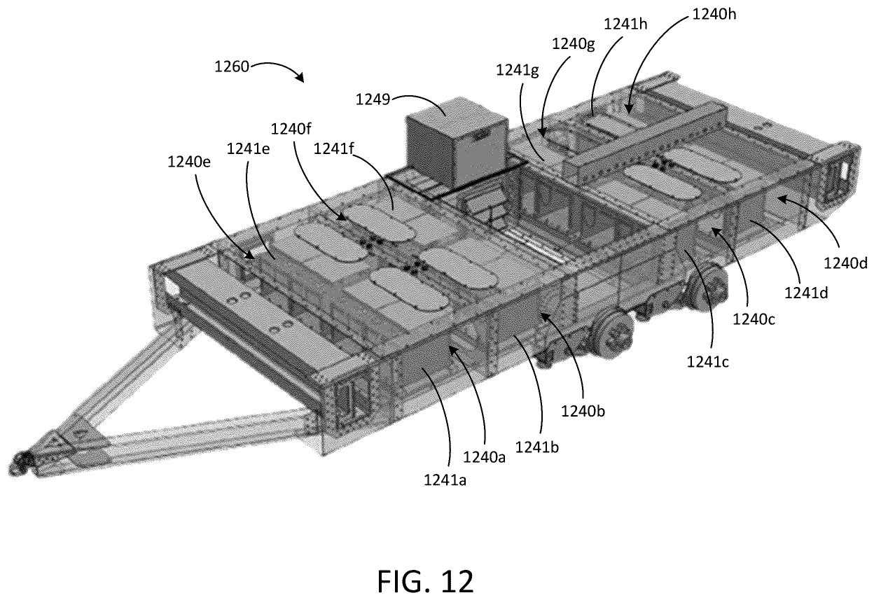

In some embodiments, a mobile solar generator can include a plurality of batteries stored in one or more battery compartments. FIG. 12 shows an example mobile solar generator chassis. In the example embodiment, chassis 1260, which can be included in or as a part of a housing of the mobile solar generator, includes a plurality of battery compartments 1240a-140h, each housing a corresponding battery 1241a-141h. In some examples, each battery compartment 1240a-140h includes more than one battery, such as two, three, or more batteries. In an example embodiment, a mobile solar generator comprises at least 8 battery compartments, and each battery compartment holds at least two batteries.

In the illustrated examples, chassis 1260 supports chiller 1249, which can be used to provide conditioned air to control the climate of one or more battery compartments, for example, via one or more fans.

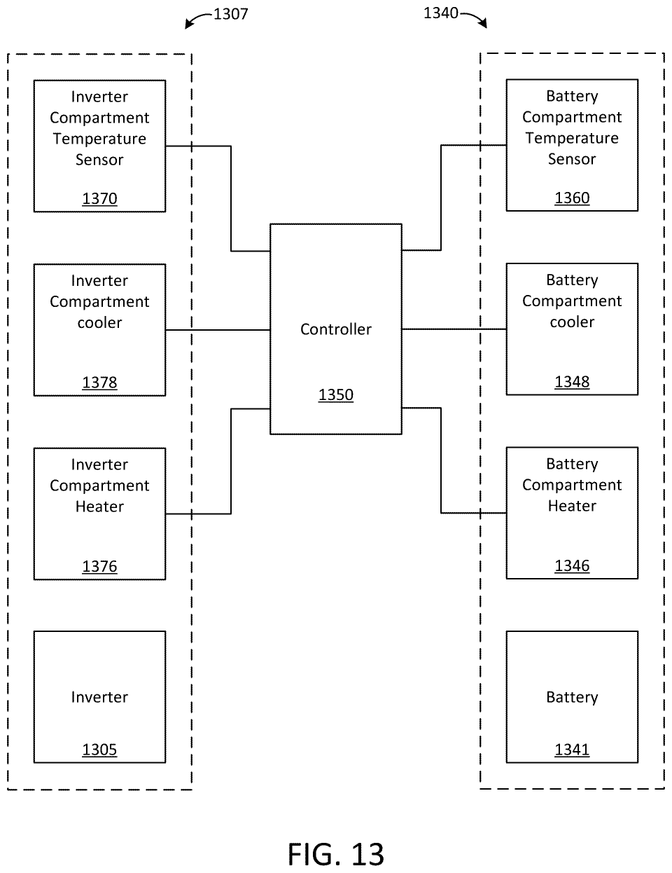

In some examples, a controller of the mobile solar generator can be configured to control the climate within a battery compartment. FIG. 13 shows an example battery compartment climate control system. In the illustrated example, a controller 1350 is in communication with a temperature sensor 1360 configured to output a signal representative of a temperature of the battery compartment 1340. The controller 1350 is further in communication with a battery compartment heater 1346 (e.g., one or more electric heaters) and a battery compartment cooler 1348 (e.g., one or more fans and a chiller as shown in FIG. 11). As shown, temperature sensor 1360, heater 1346, and cooler 1348 are positioned within a battery compartment 1340.

The controller can be configured to determine a temperature of the battery compartment and selectively heat or cool the battery compartment via heater 1346 or cooler 1348 in order to maintain the battery compartment within a predetermined temperature range. For example, in some embodiments, the controller 1350 can compare the temperature to a lower temperature threshold and, if the temperature is below the lower temperature threshold, activate the heater 1346 to increase the temperature of the battery compartment. Similarly, in some embodiments, the controller 1350 can compare the temperature to an upper temperature threshold and, if the temperature is above the upper temperature threshold, activate the cooler 1348 (e.g., a chiller, a fan, or both) to decrease the temperature of the battery compartment. In some cases, maintaining batteries within a predetermined range of temperatures can allow the batteries to operate at a higher efficiency and/or charge storage capacity compared to similar batteries outside of the predetermined range of temperatures.

In some examples, a mobile solar generator further includes supplemental batteries which can be used to power peripheral lighting or accessories. For instance, the mobile solar generator can include peripheral lights which enable users to, for example, deploy and/or service the mobile solar generator in dark environments. In some examples, supplemental batteries can be used to power battery compartment climate control systems, such as powering one or more heaters, chillers, fans, or the like. In some embodiments, the mobile solar generator includes a plurality of lights supported by the housing of the mobile solar generator, and in some such examples, the controller is configured to control illumination of the plurality of lights. In some examples, the controller can cause such lights to illuminate in response to a user input. Additionally or alternatively, controller can cause lights to illuminate automatically, for example, due to an alarm or warning.

As described herein, in some examples, one or more inverters are stored in one or more inverter compartments. In some such embodiments, one or more inverter compartments can be climate controlled in order to maintain a climate within the inverter compartment, such as maintaining a temperature within the inverter compartment within a predetermined temperature range. In some examples, the components for heating, cooling, measuring, and controlling a temperature of an inverter compartment can be similar to those described above with respect to the battery compartment climate control.

For instance, the example of FIG. 13 further shows an example inverter compartment climate control system. In the illustrated example, controller 1350 is in communication with an inverter compartment temperature sensor 1370 configured to output a signal representative of a temperature of the inverter compartment. The controller 1350 is further in communication with an inverter compartment heater 1376 (e.g., one or more electric heaters) and an inverter compartment cooler 1378 (e.g., one or more fans and a chiller similar to as shown with respect to a battery compartment in FIG. 11). As shown, temperature sensor 1370, heater 1376, and cooler 1378 are positioned within an inverter compartment 1307.

The controller can be configured to determine a temperature of the inverter compartment and selectively heat or cool the inverter compartment via heater 1376 or cooler 1378 in order to maintain the inverter compartment within a predetermined temperature range. For example, in some embodiments, the controller 1350 can compare the temperature to a lower temperature threshold and, if the temperature is below the lower temperature threshold, activate the heater 1376 to increase the temperature of the inverter compartment 1307. Similarly, in some embodiments, the controller 1350 can compare the temperature to an upper temperature threshold and, if the temperature is above the upper temperature threshold, activate the cooler 1378 (e.g., a chiller, a fan, or both) to decrease the temperature of the inverter compartment. In some cases, maintaining inverter within a predetermined range of temperatures can prevent undesired inverter operation at extreme temperatures.

In some examples, an inverter climate control system can share one or more components with a battery compartment climate control system. For example, in some embodiments, a chiller (e.g., chiller 149) can be configured to condition air (e.g., via a refrigerant circuit) that can be used to cool both a battery compartment and an inverter compartment. In other examples, the inverter climate control system and a battery climate control system can use separate components for heating and/or cooling. In some cases, even if separate heating and/or cooling components are used, a common controller (e.g., 1350) can be used to control the climate control system for both the battery compartment(s) and inverter compartment(s). In other examples, each can include a separate climate control system controller.

In some examples, controller 1350 can be configured to perform functions described with respect to controller 150 in FIG. 5 and/or controller 750 in FIG. 7. For instance, in some examples, a mobile solar generator includes a single controller configured to, among other things, control solar array and outrigger deployment, move the solar array to track the sun, control a battery compartment and/or inverter compartment climate, or any combination of such functions.

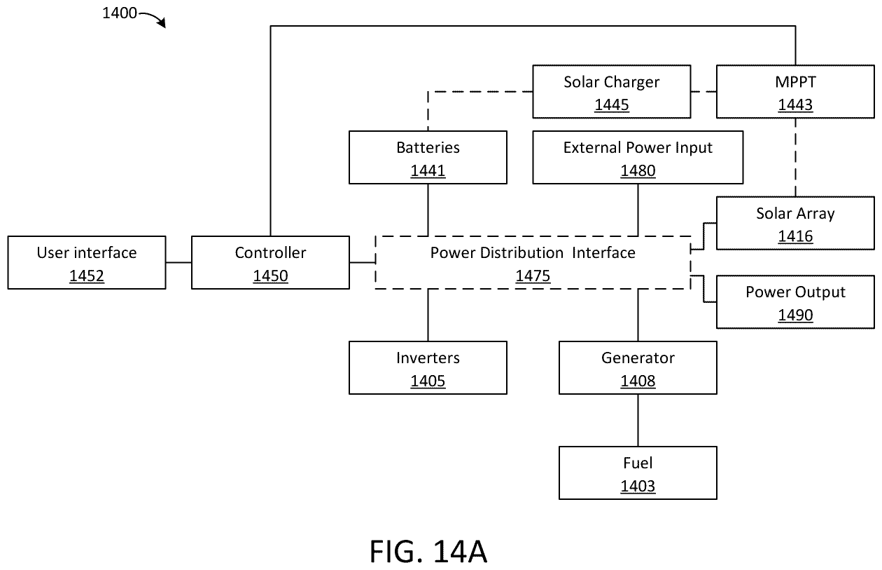

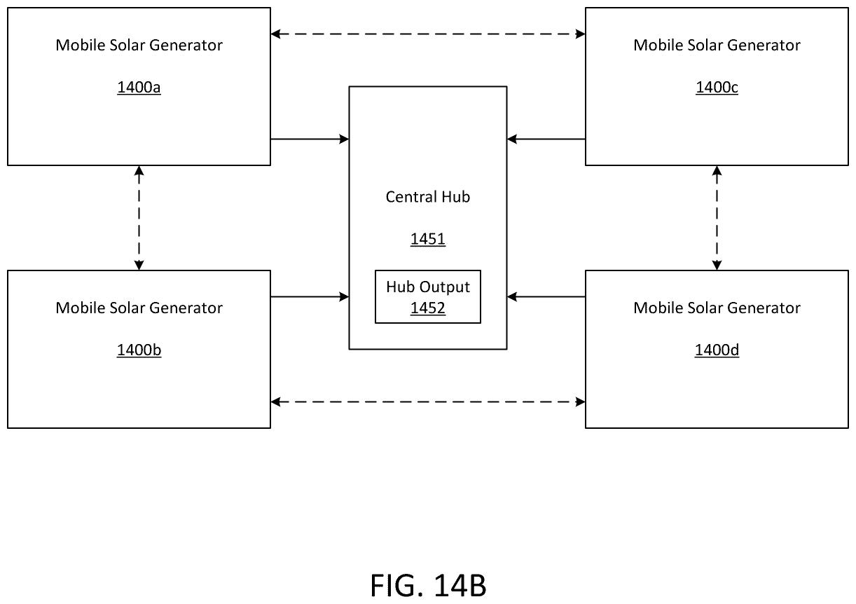

In some embodiments, electrical power can be distributed to and from various components of the mobile solar generator. FIG. 14A shows an example diagram showing various aspects of a mobile solar generator. In the illustrated example, a mobile solar generator comprises, among other things, a controller 1450, one or more batteries 1441, one or more inverters 1405, a generator 1408, and a solar array 1416. The mobile solar generator 1400 further includes an external power input 1480 and a power output 1490.

A power distribution interface 1475 is in communication with various such components and can be configured to facilitate providing electrical power from one component to another. In some examples, power distribution interface comprises a series of switches or other such elements configured to control electrical communication between components. In some embodiments, controller 1450 is configured to control the power distribution interface in order to selectively provide electrical power from one component to another. Additionally or alternatively, in some examples, the functionality of the power distribution interface can be performed via one or more system components, such as one or more inverters 1405.

In some embodiments, a mobile solar generator includes a solar charger 1445 configured to provide charge to the one or more batteries 1441. In some examples, the solar charger 1445 is configured to perform maximum power point tracking (MPPT) to control power output from the solar array 1416 in order to draw a maximum level of power from the solar array 1416. In some examples, controller 1450 is configured to control operation of the solar charger, for example, to control when power is being provided from the solar array 1416 to the one or more batteries 1441, for example, via the solar charger 1445. In some such examples, the solar array 1416 is not connected to the power distribution interface 1475, but instead only provides power to the one or more batteries 1441 through the solar charger 1445.

In some example implementations, controller 1450 can be configured to cause the generator 1408 to provide electrical energy to one or more batteries 1441, for example, to charge batteries 1441. Additionally or alternatively, controller 1450 can be configured to cause the generator to provide electrical energy directly to a power output 1490, for example, to a load connected thereto.

The example of FIG. 14A, the mobile solar generator further includes a user interface 1452 in communication with the controller 1450. User interface can include one or more inputs (e.g., a touchscreen, mouse, keyboard, etc.) by which a user can input one or more commands or requests to the controller 1450 and one or more outputs (e.g., a display, speaker, etc.) by which the controller 1450 can output information to be received by a user.

In some embodiments, the controller 1450 is configured to determine status information regarding one or more mobile solar generator components. In various examples, controller can determine an amount of power being generated at the solar array 1416, a state of charge of the one or more batteries 1441 (e.g., an aggregate state of charge of a plurality of batteries and/or an individual state of charge of each of a plurality of batteries), an amount of power being drawn at power output 1490, an amount of power available at power input 1480, and/or other status information. In some such examples, controller 1450 is configured to output status information via the user interface 1452, such as via a display.

In some examples, the controller 1450 can control power distribution based on determined information regarding one or more components. For instance, in an example embodiment, the controller 1450 is configured to determine a state of charge of one or more batteries 1441, compare the determined state of charge to a threshold state of charge, and, if the state of charge is below the threshold state of charge, cause the generator 1408 to provide electrical power to the one or more batteries 1441. Thus, in some embodiments, the generator 1408 can be used to charge the one or more batteries 1441 if the state of charge of the one or more batteries 1441 is below a threshold. In some cases, the threshold can be set and/or adjusted by a user via user interface 1452.

In some examples, the controller 1450 can prioritize charging the one or more batteries 1441 via the solar array 1416, for example, rather than generator 1408. For example, in some embodiments, the controller 1450 is further configured to determine an amount of energy provided to the one or more batteries 1441 from the solar array 1416, and if the state of charge is below the threshold state of charge and the amount of energy provided to the one or more batteries 1441 from the solar array 1416 is below a threshold amount of energy, then cause the generator 1408 to provide electrical energy to the one or more batteries 1441.

Similar to as described elsewhere herein, in some examples, controller 1450 can be configured to perform functions described with respect to controller 150 in FIG. 5, controller 750 in FIG. 7, and/or controller 1350 in FIG. 13. For instance, in some examples, a mobile solar generator includes a single controller configured to, among other things, control solar array and outrigger deployment, move the solar array to track the sun, control a battery compartment and/or inverter compartment climate, control power distribution among mobile solar generator components, or any combination of such functions.

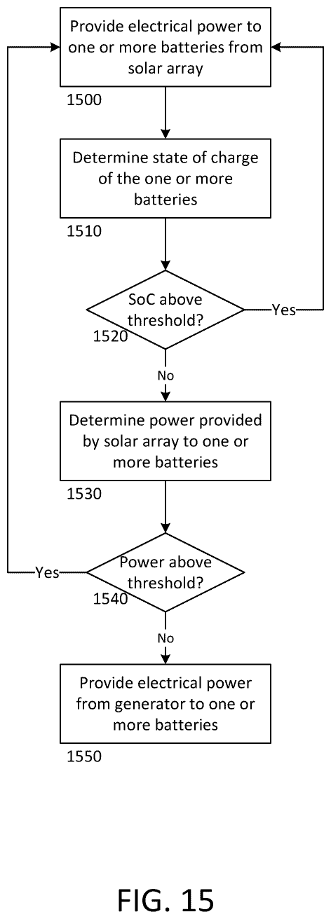

FIG. 15 shows an example process of charging one or more batteries. The example process includes providing electrical power to one or more batteries from a solar array 1500 and determining a state of charge of the one or more batteries 1510. The process includes determining if a state of charge of the one or more batteries is above a threshold state of charge 1520 (e.g., if an aggregate state of charge of a plurality of batteries is above an aggregate state of charge threshold and/or if an individual state of charge of any one of a plurality of batteries is above an individual battery state of charge threshold). If so, then the process continues by continuing to provide electrical power to the one or more batteries from the solar array 1500 and monitoring the state of charge of the one or more batteries (e.g., via steps 1510 and 1520).

However, if the state of charge of the one or more batteries is below the threshold state of charge, the process proceeds to determining an amount of power provided by the solar array to the one or more batteries 1530 and determining if the amount of power is above a threshold amount of power 1540. If so, then the process repeats by continuing to provide electrical power to the one or more batteries from the solar array 1500 and monitoring the state of charge of the one or more batteries (e.g., via steps 1510 and 1520).

However, if the amount of power provided by the solar array to the one or more batteries is below the threshold amount of power, the process includes providing electrical power from a generator to the one or more batteries 1550. For example, the generator can be used to make sure the one or more batteries stay above a threshold minimum state of charge in order to maintain battery health and/or ensure that the one or more batteries contain enough charge to power a load as desired.

In some examples, the process of FIG. 15 can be performed by a controller (e.g., controller 1450) of a mobile solar generator. It will be appreciated that, in various embodiments, various steps in the process shown in FIG. 15 can be omitted or permuted. For example, in some embodiments, an amount of power provided by the solar array to the one or more batteries is continuously or periodically monitored, and not necessarily only after determining whether the state of charge of the one or more batteries is above a threshold. Additionally, in some embodiments, as described herein, if the state of charge is not above the threshold, power can be provided to the one or more batteries from the generator regardless of the amount of power provided by the solar array.

As noted above, in some examples, in some embodiments, a threshold state of charge can be an aggregate state of charge, for example, corresponding to a total state of charge of a plurality of batteries. Additionally or alternatively, in some embodiments, a threshold state of charge can be an individual state of charge threshold applied individually to each of a plurality of batteries.

As shown in the illustrated example of FIG. 14A, mobile solar generator includes an external power input 1480. In some examples, the external power input 1480 is configured to provide energy received from an external source, such as shore power, directly to the one or more batteries 1441, for example, to charge the one or more batteries 1441. In some examples, the external power input 1480 can be used to charge the one or more batteries 1441 when other sources of charge (e.g., solar array 1416 and/or generator 1408) are unavailable (e.g., if it is dark and/or the generator is out of fuel). Additionally or alternatively, in some cases, the external power input 1480 can provide electrical power to charge the one or more batteries 1441 when the mobile solar generator is otherwise in storage, such as before it is transported to a location for use.

In some embodiments, the external power input 1480 and/or power output 1490 can be connected to an electric grid, such as a large scale grid and/or a microgrid. The mobile solar generator can provide energy to and/or draw energy from such an electric grid. Additionally or alternatively, multiple solar generators can be used in combination with one another. Multiple mobile solar generators can be coupled to one another, for example, to form a microgrid. Such a configuration can increase the power capacity and/or power output of the mobile solar generator(s). In some embodiments, multiple mobile solar generators can be connected in parallel to provide a greater maximum current output compared to a single mobile solar generator. Additionally or alternatively, in some examples, two or more solar generators can be cascaded.

In some embodiments, a plurality of mobile solar generators can be connected in parallel to a central hub such that the mobile solar generators each provide power to the central hub. The central hub can provide power to one or more loads using power received from the plurality of mobile solar generators. In some embodiments, each of the plurality of mobile solar generators can be in communication with at least one other mobile solar generator of the plurality of mobile solar generators (e.g., via a wire) in order so synchronize phase information between mobile solar generators outputting AC power.

FIG. 14B shows a plurality of mobile solar generators configured to provide power to a central hub. In the illustrated example, mobile solar generators 1400a, 1400b, 1400c, 1400d are configured to provide power to a central hub 1451, for example, via respective power outputs of each mobile solar generator. The central hub 1451 includes a hub output 1452 that can provide power having a higher ampacity compared to an individual mobile solar generator. As shown by broken lines in FIG. 14B, mobile solar generators can be in communication with one another, for example, to communicate information regarding phase or other details to facilitate combining power output from the various mobile solar generators at the hub output. In some examples, the mobile solar generators 1400a, 1400b, 1400c, 1400d can form a microgrid with or without central hub 1451.

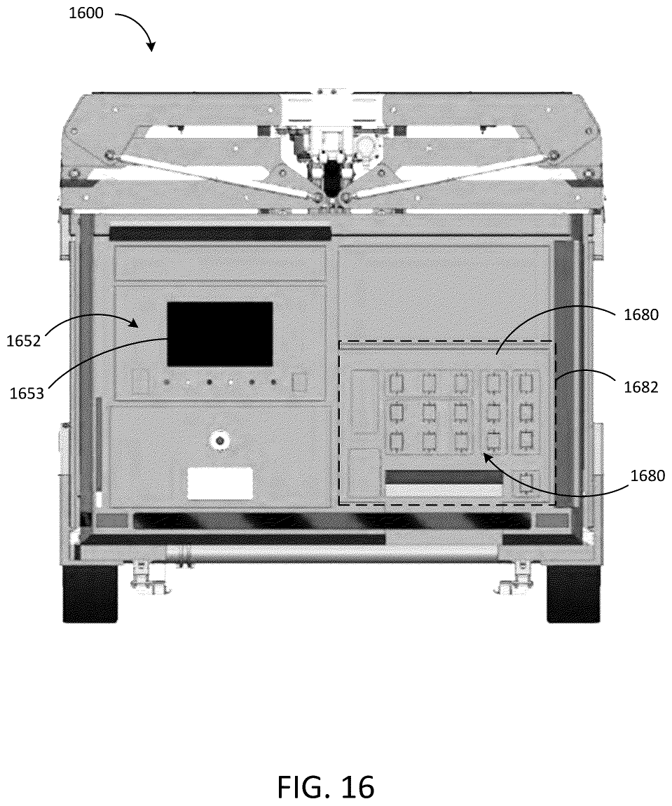

In some embodiments, mobile solar generator includes a series of collapsed or folded solar panels supported by a housing. The mobile solar generator also includes outriggers which retract into the housing and can further include additional electrical components such as batteries, inverters, load connections, circuit breakers, switches, etc. FIG. 16 shows a back view of an example mobile solar generator. As illustrated in FIG. 16, the mobile solar generator 1600 includes an interface panel 1675 comprising a plurality of plugs 1680 for connecting to one or more cables. In various embodiments, plugs can include camlock connections, outlet connections, or other interfaces configured to connect to a cable for providing or receiving power.

In some examples mobile solar generator 1600 includes one or more camlocks, one or more twist lock connectors, and one or more NEMA connectors. In some examples, mobile solar generator includes multiple types of connectors, such as 5-30R NEMA connectors and 5-20R NEMA connectors. In some examples, different connectors are configured for outputting different power outputs, such as single phase or three phase power. Additionally or alternatively, different connectors can be rated for, for example, different amounts of electrical current. For instance, an example mobile solar generator includes a set of female camlocks configured to output 120 or 208 VAC in three phases up to 100 amps, one or more NEMA L21-20R twist lock connectors configured to output 120 or 208 VAC in three phases up to 20 amps, one or more CS6369 twist lock connectors configured to output 120 or 208 VAC in a single phase up to 50 amps, one or more NEMA 5-30R connectors configured to output 120 VAC in a single phase up to 30 amps, and one or more 5-20R connectors configured to output 120 VAC in a single phase up to 20 amps.

In some examples, the plugs 1680 of mobile solar generator can include one or more electrical inputs in addition to one or more electrical outputs. The one or more electrical inputs can be used to charge the batteries of the mobile solar generator using an external source without using the integrated power generation of the mobile solar generator (e.g., solar panels, generator). For instance, in some embodiments, one or more of the camlock connections can connect to an external power source, such as a shore power source, and receive electrical power therefrom. Such received electrical power can be provided to one or more batteries to charge such batteries.

In some embodiments, a mobile solar generator 1600 includes an openable hatch 1682 connected to the housing proximate a cable interface location where one or more cables can be connected to the mobile solar generator, such as at one or more camlock connections or other interfaces (e.g., proximate plugs 1680). In some embodiments, the openable hatch can be closed to prevent access to the cable interface location and can be opened to permit convenient access to cable interface location. In some examples, the mobile solar generator comprises a sensor configured to sense whether the openable hatch 1682 is open or closed. In some such examples, a controller in communication with the sensor and is configured to determine whether the openable hatch is opened or closed. In some such examples, the controller is configured to prevent transmission of electrical energy from one or more plugs 1680 unless the openable hatch is in the closed position. This can prevent a person or other object from easily accessing or accidentally contacting powered plugs and reduce a risk of shock, short circuits between plugs, or other undesired consequences. As described elsewhere herein, in some embodiments, a mobile solar generator controller can be configured to control power distribution between various mobile solar generator components, and in some examples, can prevent power output to one or more plugs if the hatch is in an open position.

The openable hatch 1682 of the mobile solar generator 1600 can include at least one lock. In some embodiments, the lock can be a solenoid lock. The lock can be configured such that, when one or more connectors behind a closed hatch are energized, the solenoid can trigger a door lock and disable access to the contents behind the openable hatch 1682. In some such embodiments, the openable hatch 1482 combined with a lock (e.g., a solenoid lock) can prevent a user from accessing the energized connectors and/or cables, which can help prevent injury to a user or damage to the cables and/or connectors. The solenoid can be configured to disable the door lock when the connectors are not energized, thereby allowing a user to access the contents behind the openable hatch 1482.

The mobile solar generator 1600 further includes a user interface 1652. The illustrated example includes a display 1653, which can display information about the mobile solar generator. In some examples, display 1653 can display information such as power being generated, battery charge level (e.g., of one and/or a plurality of batteries), the load level, and other information. In some examples, a controller is in communication with the user interface 1652 and is configured to determine such information and output such information via display 1653. In some embodiments, display 1653 comprise a touchscreen that can receive a user input. Additionally or alternatively, in some examples, interface 1652 includes one or more buttons, switches, knobs, or other components by which a user can input information. A mobile solar generator controller can receive inputs via interface 1652, such as, for example, a command to deploy a solar array or outriggers, acknowledgement of one or more safety checks, etc.

In some examples, a mobile solar generator can include one or more sensors, for example, positioned on a sensor tower supported by the mobile solar generator. Returning to FIGS. 4A and B, mobile solar generator 100 includes a sensor tower 170. In various embodiments, the sensor tower 170 of mobile solar generator 100 can include a variety of sensors including but not limited to, wind sensors, solar irradiance sensors, audio/visual sensor (e.g., security camera, microphones), and thermal sensors. In some examples, the sensor tower 170 can include one or more antennae such as a cellular data antenna or a GPS antenna. Including a sensor tower 170 with the mobile solar generator 100 can be advantageous as it can provide important data related to the operation of the solar generator. For example, having a wind sensor on the sensor tower 170 can provide windspeed information, which can inform whether it is safe to have the mobile solar generator 100 in a fully open configuration. In some examples, the sensor tower is extendable/retractable from the mobile solar generator. In some examples, a sensor tower can be coupled to the housing of the mobile solar generator. Additionally or alternatively, a sensor tower can be coupled to the solar array.

In some embodiments, the sensor tower 170 can be tiltable relative to the solar array 116. In some such examples, the controller can be configured to control the tilt of the sensor tower 170 relative to the solar array 116.

As described elsewhere herein, in some embodiments, the solar array 116 can be tiltable relative to the adjustable support pillar 112 (e.g., as shown by “C” in FIGS. 4A-4B), and the controller can be configured to control the tilt of the solar array 116 relative to the adjustable support pillar 112. In some embodiments, the controller can be configured to control the tilt of the sensor tower 170 relative to the solar array 116 to orient the sensor tower 170 in a direction normal to a level plane. For instance, in some embodiments, the controller is configured to control a tilt of the solar array 116 and the sensor tower 170 coupled to the solar array 116. Additionally, as described herein, in some examples, a controller is configured to control one or more outriggers in order to level a housing of the mobile solar generator. In some embodiments, the controller is configured to level the housing, control the tilt of the solar array 116 relative to the level housing, and control the tilt of the sensor tower 170 relative to the solar array 116 such that the sensor tower 170 extends in a direction perpendicular to the leveled housing.

The sensor tower can help protect the mobile solar generator against various elements (e.g., wind), which can cause damage to the solar array if not mitigated. In some the sensor tower can be adjusted so that it is unobstructed by the solar array, for example, so that the solar array 116 does not block wind that would otherwise be sensed by a wind sensor on sensor tower. In some embodiments, the sensor tower 170 can remain unobstructed by the solar array 116 before, during, and after any movement by the solar array 116, for example, by extending upward from the solar array 116 and remaining perpendicular to a level plane. By being able to sense the various conditions around the solar array, the mobile solar generator can undergo the various protective steps described herein to mitigate against the elements.

The sensor tower may be positionable in a variety of configurations. The sensor tower 170 can be configured to move between a stored sensor tower configuration (e.g., folded down to extend in a direction parallel with the surface of one or more solar panels of solar array 116) and a deployed sensor tower configuration (e.g., extending upward from the solar array 116 and remaining perpendicular to a level plane). In some examples, the controller is configured to control movement of the sensor tower 170 to move the sensor tower 170 between the stored sensor tower configuration and the deployed sensor tower configuration and receive wind information from the wind sensor 172 when the sensor tower 170 is in the deployed sensor tower configuration.

In some embodiments, a mobile solar generator 100 can include a housing 118, an adjustable support pillar 112 coupled to the housing 118 and configured to extend upward from the housing 118, a solar array 116 comprising one or more solar panels 102, and a wind sensor 172. In some examples, mobile solar generator 100 includes a controller in communication with the wind sensor 172. The solar array 116 can be supported by the adjustable support pillar 112 such that a height of the solar array 116 is adjustable via the adjustable support pillar 112 (e.g., as represented by “A” in FIGS. 4A-4B). In some embodiments, as described herein, the solar array 116 can be configured to move between a stored solar array configuration and a deployed solar array configuration. In some examples, in the stored solar array configuration, the adjustable support pillar 112 holds the solar array 116 such that a center of the solar array 116 is between approximately 8 feet and 9 feet above the ground, and in the deployed solar array configuration, holds the solar array 116 such that the center of the array is between 12 feet and 15 feet off the ground. The mobile solar generator 100 of FIGS. 4A and 4B include a solar array 116 shown in a deployed solar array configuration.

As described herein, a mobile solar generator controller can perform a variety of functions. In some examples, the controller can be configured to control movement of the solar array 116 to move the solar array between a stored solar array configuration and a deployed solar array configuration. The controller can receive wind information from the wind sensor 172 representative of at least a wind strength, and, if the solar array 116 is in the deployed solar array configuration and the wind information satisfies a predetermined threshold (e.g., is above a threshold wind strength), the controller can move the solar array 116 into a safe mode configuration different from the deployed solar array configuration. For example, in some embodiments, the controller can move the solar array 116 into the safe mode configuration if the wind strength is above a wind strength threshold, which can prevent strong winds from damaging a deployed solar array and/or other components of the mobile solar generator 100 due to the wind catching the deployed solar array 116.

In some examples, a controller can receive and act on wind information if the solar array is in the stored solar array configuration. For instance, in some examples, if the solar array 116 is in the stored solar array configuration and the wind information satisfies a first predetermined threshold (e.g., is above a threshold wind strength), the controller can maintain the solar array 116 in the stored solar array configuration. Additionally or alternatively, in some cases, a predetermined threshold can include a condition under which it is safe to deploy a solar array. For instance, in some embodiments, the controller can be configured to, if the solar array 116 is in the stored solar array configuration and the wind information satisfies a predetermined threshold (e.g., is below a threshold wind strength), the controller can move the solar array 116 into the deployed solar array configuration.

In some embodiments, a safe mode configuration can include a configuration between the deployed solar array configuration and the stored solar array configuration. For instance, in some embodiments, the deployed solar array configuration can include the solar array being raised above the housing to a deployed height via the adjustable support pillar. In some examples, the deployed height corresponds to the top of the adjustable support pillar 112 being between approximately 12 feet and 15 feet above the ground. The controller can be configured to move the solar array 116 into the safe mode configuration by adjusting the adjustable support pillar 112 to lower the solar array 116 to a safe mode height.

Additionally or alternatively, in some examples, moving the solar array 116 to a safe mode configuration comprises moving one or more solar panels relative to one or more other solar panels. For instance, as described herein, in some examples, mobile solar generator 100 can include a solar array 116 comprising a plurality of solar panels 102. In some embodiments, the controller is configured to move the solar array 116 into the safe mode configuration by moving the solar array 116 into a closed solar array configuration. In some examples, the closed solar array configuration includes the stored solar array configuration. In some such examples, moving the solar array into the safe mode configuration comprises moving the solar array to the stored solar array configuration. In other examples, the closed solar array configuration is different from the stored solar array configuration. In some examples, the stored solar array configuration includes the closed solar array configuration, but the closed solar array configuration does not necessarily require the solar array to be in the stored solar array configuration. For instance, in an example, in moving to the safe mode configuration, the solar array tilts to be level with the ground and then folds or otherwise reduces in size such as described elsewhere herein. In some cases, in moving to the safe mode configuration, the adjustable support pillar 112 remains at the deployed height.

For instance, in some examples, in a stored solar array configuration, fewer solar panels are exposed compared to the deployed solar array configuration. With reference to FIGS. 1, 4A, and 4B, a stored solar array configuration shown in FIG. 1 shows four exposed solar panels 102, whereas the deployed solar array configuration shown in FIGS. 4A and 4B shows twelve exposed solar panels 102. In the illustrated examples of FIGS. 4A and 4B, in the deployed solar array configuration, the solar array 116 is raised above housing 118 by adjustable support pillar 112. In the example of FIG. 1, in the stored solar array configuration, the adjustable support pillar does not raise the solar array 116 above the housing 118.

As described, in some examples, moving the solar array to the safe mode configuration comprises moving the solar array to the stored solar array configuration. In other examples, the safe mode configuration is different from the stored solar array configuration. For instance, in some examples, in the safe mode configuration, the controller can adjust the solar array so that fewer solar panels are exposed compared to the deployed solar array configuration, such as the differences in the exposed solar panels 102 between FIGS. 1 and 4A-4B. This can reduce the area of the solar array, which can reduce the forces experienced by the solar array by high wind. However, in some cases, one or more solar panels remain exposed in the safe mode configuration, which permits the mobile solar generator to continue to generate power from the solar array even while in the safe mode configuration.

In some examples, moving the solar array to the safe mode configuration does not include lowering the solar array via the adjustable support pillar. Instead, in some examples, the solar array 116 is reduced in size so that fewer solar panels are exposed compared to the deployed solar array configuration, and the total area of the solar array is less than in the deployed solar array configuration. However, the safe mode configuration does not necessarily require lowering the solar array toward the housing via an adjustable support pillar. In some examples, moving the solar array to the safe mode configuration comprises lowering the solar array via the adjustable support pillar to a height between the stored solar array configuration and the deployed solar array configuration.

Various configurations are possible for changing a solar array size, for example, to move the solar array between a stored solar array configuration, a deployed solar array configuration, and, in some embodiments, a separate safe mode configuration, such as described elsewhere herein.

In some examples, moving the solar array into the safe mode configuration (e.g., the stored solar array configuration or a separate safe mode configuration) involves moving the solar array (e.g., 116) but not moving any already-deployed outriggers (e.g., 114). The outriggers (e.g., 114) can maintain a steady base for the mobile solar generator during windy conditions.

As described, in some embodiments, a mobile solar generator controller can act in response to wind information, such as wind speed detected via a wind sensor. In some embodiments, the controller can receive wind information from the wind sensor 172 representative of at least a wind strength, and, if the solar array 116 is in the deployed solar array configuration and the wind information satisfies a predetermined threshold (e.g., is above a threshold wind strength), the controller can move the solar array 116 into a safe mode configuration different from the deployed solar array configuration.

In some examples wherein the safe mode configuration is different from the stored solar array configuration, the controller is configured to compare the wind information to a second predetermined threshold corresponding to a second wind speed, the second wind speed being greater than the first wind speed. In some such examples, if the wind information satisfies the second predetermined threshold, the controller is configured to move the solar array into the stored solar array configuration.

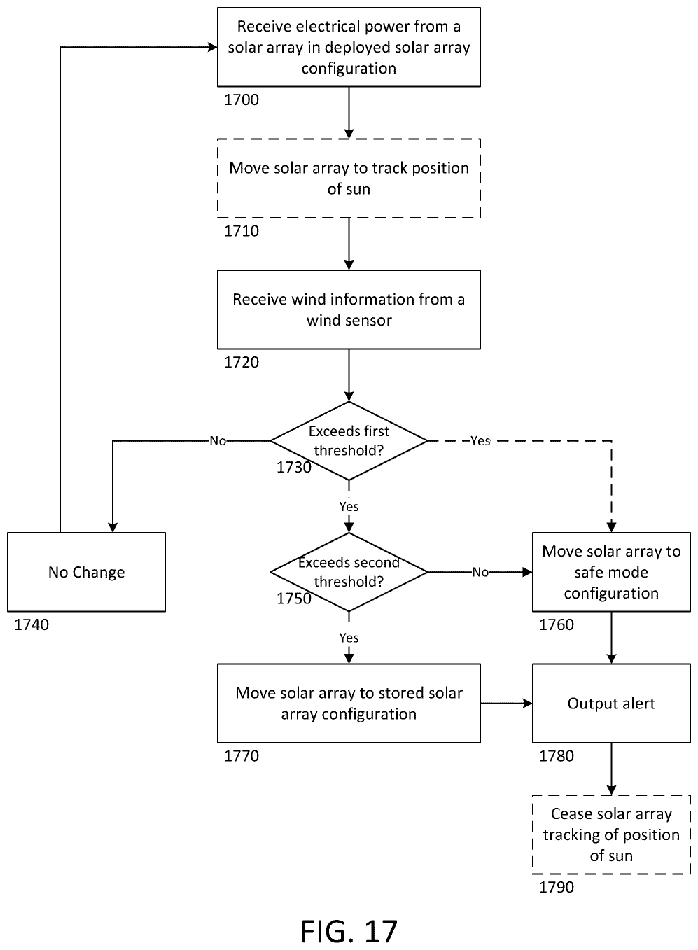

FIG. 17 shows an example process flow diagram showing example response of the mobile solar generator to wind information. In some embodiments, a mobile solar generator controller can be configured to implement the process of FIG. 17. In the illustrated example, the mobile solar generator can receive electrical power from a solar array in a deployed solar array configuration (1700). As described herein, ins some examples, the solar array can be moved to track the sun (1710). The mobile solar generator can receive wind information from a wind sensor (1720) and determine if the wind information exceeds a first threshold (1730), for example, if a wind speed that exceeds a first wind speed threshold. If not, there is no change (1740) and the mobile solar generator continues to operate (e.g., with steps 1700, 1710, 1720).

In the illustrated embodiment, if the wind information does exceed a first threshold (1730), the mobile solar generator can determine if the wind information exceeds a second threshold (1750), for example, if the wind speed exceeds a second wind speed threshold greater than the first windspeed threshold. If so, the mobile solar generator can move the solar array to the stored solar array configuration (1770). In some examples, if the wind information does not exceed the second threshold (1750), then the mobile solar generator can move the solar array to a safe mode configuration (1760). As described herein, in some examples, the safe mode configuration is different from the stored solar array configuration. In other examples, wherein the safe mod configuration is the same as the stored solar array configuration, if the wind information exceeds the first threshold (1730), the mobile solar generator can move the solar array to the safe mode configuration that is the stored solar array configuration.

In some examples, whether the solar array is moved to the stored solar array configuration or a separate safe mode configuration in response to wind information satisfying one or more predetermined thresholds, the mobile solar generator can be configured to output an alert (1780), for example, to warn people within the vicinity of the mobile solar generator of automated movement of one or more mobile solar generator aspects. Such alerts can include playing one or more sounds, such as via one or more speakers, and/or illuminating one or more lights of the mobile solar generator. Additionally or alternatively, in some examples, outputting an alert comprises sending one or more alerts to a remote location, such as via a network, for example, to inform a remotely located user that the solar array configuration has changed. I some examples, after moving the solar array into a stored solar array configuration or a separate safe mode configuration, the mobile solar generator ceases tracking of the position of the sun (1790).

The solar controller can act in response to a variety of wind speeds. In some embodiments, a first threshold is approximately 50 miles per hour, and if the wind speed exceeds 50 miles per hour, the mobile solar generator moves the solar array into the safe mode configuration. In some examples, such safe mode configuration is the stored solar array configuration, such that if the windspeed is greater than 50 miles per hour, the mobile solar generator moves the solar array to the stored solar array configuration.

In some embodiments, if the windspeed is above a second, greater threshold (e.g., 75 miles per hour), the mobile solar generator moves solar array into the stored solar array configuration. Thus, in some examples, a mobile solar generator controller can be configured to maintain the solar array in the deployed solar array configuration if the windspeed is below 50 miles per hour. In some embodiments, the controller moves the solar array to a safe mode configuration different from the stored solar array configuration if the windspeed is between 50 miles per hour and the second, greater threshold speed, and in some embodiments, the controller moves the solar array to the stored solar array configuration if the windspeed is above the greater threshold speed.

In some examples, the mobile solar generator can continue to monitor wind speed after moving the mobile solar generator to the stored solar array configuration or safe mode configuration, and in some such examples, move the solar array to the deployed solar array configuration or the safe mode configuration. For example, in some embodiments, the controller can be further configured to, if the solar array is in the stored solar array configuration and the wind information does not satisfy a first predetermined threshold (e.g., falling below a first threshold windspeed), keep the solar array in the stored solar array configuration. In some embodiments of the mobile solar generator, the controller can be further configured to, if the solar array is in the stored solar array configuration and the wind information does not satisfy the first predetermined threshold (e.g., does not fall below the first threshold windspeed) but does satisfy a second predetermined threshold (e.g., does fall below a second threshold windspeed, higher than the first), move the solar array into a safe mode configuration different from the deployed solar array configuration.

In some embodiments, the controller can be further configured to, if the solar array is moving from the stored solar array configuration to the deployed solar array configuration and the wind information satisfies a predetermined threshold, stop movement of the solar array. In some embodiments, the controller can be further configured to, if the solar array is moving from the stored solar array configuration to the deployed solar array configuration and the wind information satisfies the predetermined threshold, return the solar array to the stored solar array configuration.

The position of the solar array can affect the solar tracking capabilities of the mobile solar generator. In some embodiments, the controller can be further configured to move the solar array to track the position of the sun when the solar array is in the deployed solar array configuration. In some embodiments, the controller does not move the solar array to track the position of the sun when the solar array is in the safe mode configuration.

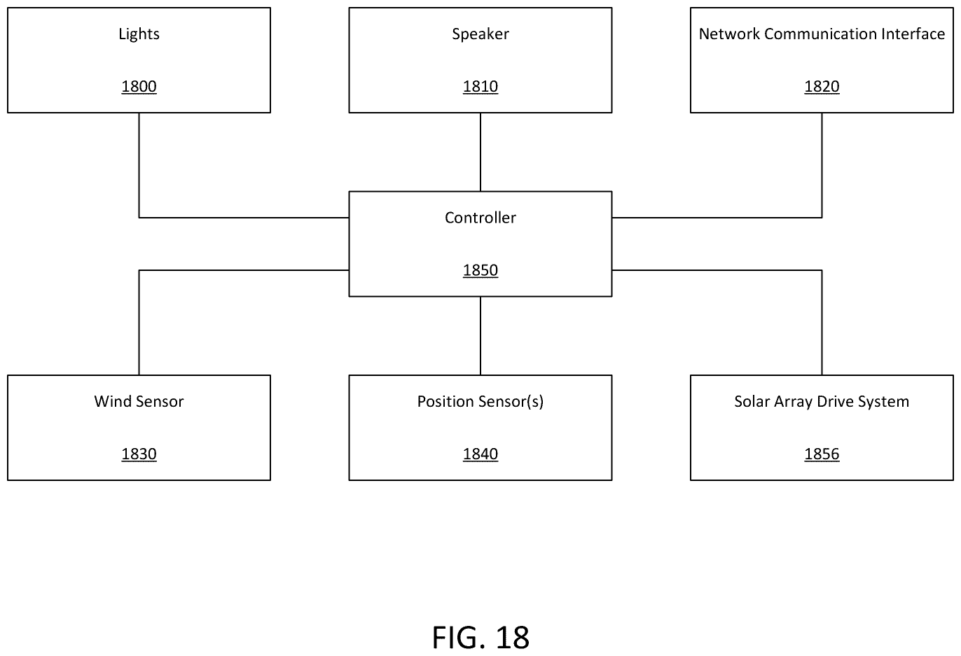

As described, in some embodiments, mobile solar generator can include a variety of audio, visual, and/or audiovisual features. FIG. 18 shows an example diagram showing various components of an example mobile solar generator. In the illustrated example, a mobile solar generator includes a controller 1850 in communication with a wind sensor 1830 and a solar array drive system 1856. In some examples, as described herein, the controller 1850 can receive wind information from wind sensor 1830 and, in some embodiments, adjust a solar array configuration based on the wind information (e.g., by moving the solar array from a deployed solar array configuration to a safe mode configuration if the wind information satisfies a predetermined threshold). Controller 1850 can be configured to move the solar array via the solar array drive system 1856.

In some embodiments, the mobile solar generator can include a speaker 1810 configured to output a sound and in communication with the controller 1850. In some examples, the controller 1850 can be configured to cause the speaker 1810 to output a warning sound while moving a solar array (e.g., 116) into a safe mode configuration. In the example of FIG. 18, the mobile solar generator includes one or more lights 1800 (e.g., one or more warning lights) controllable by the controller 1850. The controller 1850 can be configured to cause the one or more warning lights (e.g., 1800) to illuminate while moving the solar array (e.g., 116) into a safe mode configuration.

In some embodiments, the mobile solar generator can generate alerts indicating that the mobile solar generator has changed configurations. In some embodiments, the mobile solar generator can include a network communication interface 1820 in communication with the controller 1850. The controller 1850 can be configured to output a signal indicative of the solar array (e.g., 116) of the mobile solar generator moving into the safe mode configuration. In some examples, the controller 1850 can output such a signal to a remote location via the network communication interface 1820. For instance, in some examples, such an alert can be output to a variety of devices to signal to a user that the mobile solar generator is in its safe mode configuration so that the user is made aware that the solar array has been adjusted, such as in response to wind. This allows a user to react in real-time to weather changes affecting the generator.

In some embodiments, a mobile solar generator can be connected to a network (e.g., an internet of things or other system) and communicate with various network components. This can allow the mobile solar generator to connect to other devices (e.g., other mobile solar generators). The mobile solar generator may also be in communication with locations or devices remote to the mobile solar generator, for example, to provide information regarding the operation of the mobile solar generator and/or to receive command or control information from such a remote location or device.

In some embodiments, the mobile solar generator can include one or more position sensors 1840 in communication with the controller 1850, position sensor(s) 1840 each being configured to detect a position of the solar array when the solar array moves between various configurations, such as from the deployed solar array configuration to the stored solar array configuration and/or the safe mode configuration. The controller 1850 can be configured to detect a position of one or more components of the solar array and, if the solar array deviates from an expected stored solar array position as the solar array moves toward a desired configuration (e.g., a stored solar array configuration or a safe mode configuration), stop moving the solar array toward the desired configuration and output an alert based on information provided by the plurality of sensors (e.g., 1830, 1840). In some examples, the alert is output via one or more lights 1800, speakers 1810, and/or to a remote location, such as via network communication interface 1820.

Similar to as described elsewhere herein, in some examples, controller 1850 can be configured to perform functions described with respect to controller 150 in FIG. 5, controller 750 in FIG. 7, controller 1350 in FIG. 13, and/or controller 1450 in FIG. 14A. For instance, in some examples, a mobile solar generator includes a single controller configured to, among other things, control solar array and outrigger deployment, move the solar array to track the sun, control a battery compartment and/or inverter compartment climate, control power distribution among mobile solar generator components, receive wind information from a wind sensor, control a configuration of a solar array in response to received wind information, or any combination of such functions.

An example method for operating mobile solar generator 100 of FIGS. 4A-4B can include receiving electrical power from a solar array 116 in a deployed solar array configuration, receiving wind information from a wind sensor 172 representative of at least a wind strength, and if the wind information satisfies a predetermined threshold, moving the solar array 116 from the deployed solar array configuration into a safe mode configuration different from the deployed solar array configuration. Some embodiments of the method include adjusting a tilt of a sensor tower 170, the sensor tower 170 supporting the wind sensor 172, relative to the solar array 116 such that the sensor tower 170 is normal to a level plane.

Some embodiments of the method can include outputting an alert that the solar array 116 is moving into the safe mode configuration. In some embodiments of the method, the alert can include one or both of an audio alert output via one or more speakers and a visible alert including illuminating one or more lights. Some embodiments of the method include communicating an alert to a remote location indicating that the solar array 116 has moved from the deployed solar array configuration to the safe mode configuration.

The method can include moving the solar array 116 from the deployed solar array configuration into the safe mode configuration. In some embodiments of the method, moving the solar array 116 from the deployed solar array configuration into the safe mode configuration can include lowering the solar array 116 from a deployed height to a safe mode height.

The various heights can be defined relative to one another. In some embodiments of the mobile solar generator 100, the deployed solar array configuration can include the solar array 116 being at a deployed height relative to the housing 118. The safe mode configuration can include the solar array 116 being at a safe mode height relative to the housing 118. The safe mode height can be less than the deployed height. In some examples, the safe mode height is different from a height associated with the stored solar array configuration.

Additional solar panels can be included in the mobile solar generator. In some embodiments of the method, the solar array 116 can include a plurality of solar panels 102. When the solar array 116 is in the safe mode configuration, approximately one third of the solar panels 102 of the solar array 116 can be unshaded by other solar panels 102 of the solar array 116, and approximately two thirds of the solar panels 102 of the solar array 116 can be shaded by other solar panels 102 of the solar array 116. For instance, in an example embodiment, in the deployed solar array configuration, 12 solar panels 102 are exposed, while in the safe mode configuration, four solar panels 102 are exposed and the remaining eight solar panels 102 are shaded.

The methods of use can incorporate the thresholds described above. In some embodiments of the method, the predetermined threshold can include a first predetermined threshold corresponding to a first wind speed. The method can include, if the wind information satisfies a second predetermined threshold corresponding to a second wind speed, the second wind speed being greater than the first wind speed, moving the solar array 116 into a stored solar array configuration different from the safe mode configuration.

The solar tracking capabilities of the mobile solar generator can be incorporated into the mobile solar generator. Some embodiments of the method include, while receiving electrical power from the solar array 116 in the deployed solar array configuration, moving the solar array 116 to track the position of the sun and, after moving the solar array 116 from the deployed solar array configuration into the safe mode configuration, no longer moving the solar array 116 to track the position of the sun.

The above-described methods can be completed in combination with the automated deployment process. In particular, the above-described methods can be completed in accordance with the short durations described elsewhere herein.

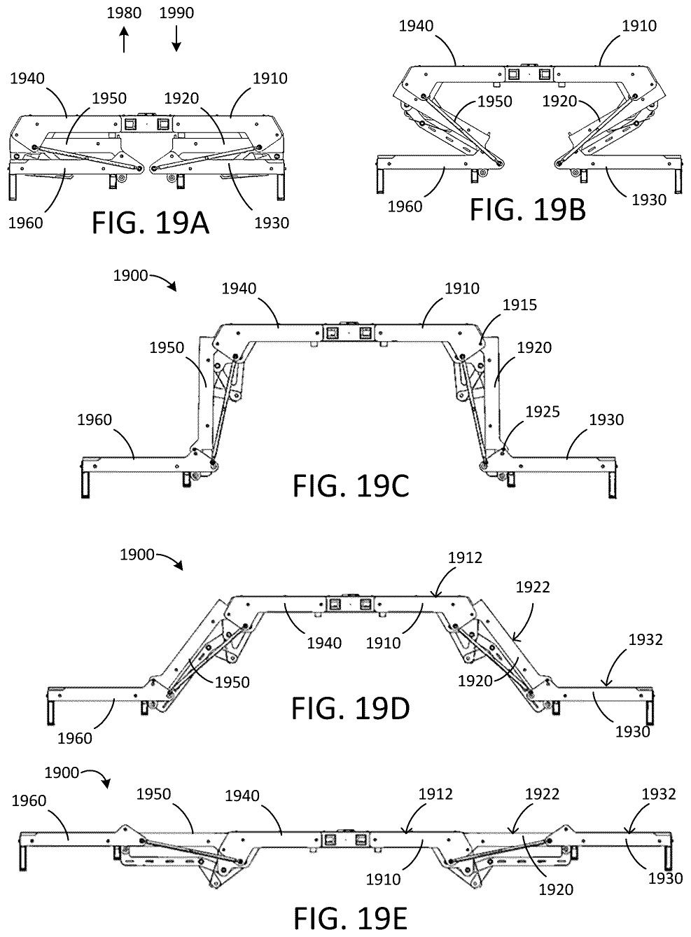

FIGS. 19A-19E show configurations of an example solar array moving between configurations. In the illustrated example, the solar array 1900 includes a first section 1910, which can include a first set of one or more solar panels, a second section 1920, which can include a second set of one or more solar panels, and a third section 1930, which can include a third set of one or more solar panels. In some examples, each of the first 1910, second 1920, and third 1930 sections include two solar panels. In some examples, first, 1910, second 1920, and/or third 1930 sections of the solar array include one or more solar panels and structure supporting the one or more solar panels, such as one or more frames, brackets, or the like.

In some embodiments, first section 1910, second section 1920, and third section 1930 include a top surface 1912, 1922, 1932, respectively, as shown in FIGS. 19D and 19E. In some examples, each top surface corresponds to a face of the one or more solar panels that receive light (e.g., from the sun) such that the corresponding solar panels generate electrical energy. In some examples, in a deployed solar array configuration (e.g., a solar array in the configuration of FIG. 19E), top surface of each of a plurality of solar panels of the solar array faces outward (1980) from the mobile solar generator (e.g., away from the housing of the mobile solar generator) and is unobstructed such that the top surface can receive light and generate electrical energy. In some such examples the top surface of each of a plurality of solar panels of the solar array is approximately coplanar with the others.

In some examples, solar array 1900 moves in order from the configurations of FIG. 19A to 19B to 19C to 19D to 19E when moving to a deployed solar array configuration. And in some examples, the solar array 1900 moves through such configurations in a reverse order when moving from a deployed solar array configuration to a closed configuration (e.g., in a stored solar array configuration or a separate safe mode configuration). In the illustrated example, the first section 1910 and third section 1930 remain parallel to one another. Additionally, in the illustrated example, the top surface 1912 of the first section 1910 and the top surface 1932 of the third section 1930 remain facing in an outward direction 1980. As shown, second section 1920 does not remain parallel to the first section 1910 or the third section 1930 as the solar array 1900 moves between the configurations of FIGS. 19A and 19E. In the illustrated example, the top surface 1922 of second section 1920 transitions from facing inward 1990 (e.g., toward the housing of the mobile solar generator), as shown in FIG. 19A, to outward 1980 (e.g., away from the housing of the mobile solar generator), as shown in FIG. 19E, as the solar array 1900 moves between the configurations of FIGS. 19A and 19E.

“Outward” (shown by arrow 1980) and “inward” (shown by arrow 1990) as used with respect to a direction a top surface of a section faces can refer to whether the top surface of the section of the solar array faces toward the housing of the mobile solar generator or away from the housing of the mobile solar generator. As described herein, in some embodiments, solar array can be moved about one or more axes of rotation, including, for example, tilting. In some cases, a solar array section can face outward, away from the mobile solar generator housing, while tilting, for example, to face the sun. Thus, in some cases, a top surface of a section of a solar array facing direction does not necessarily mean that the top surface is facing straight up relative to a ground surface or a level plane. Similarly, a top surface of a section of a solar array facing inward does not necessarily mean that the top surface is facing straight down relative to a ground surface or a level plane.

FIG. 19A shows a solar array in an example closed configuration. In the example configuration shown in FIG. 19A, the second section 1920 is underneath the first section 1910 such that the second set of solar panels is underneath the first set of one or more solar panels. In some such examples, the first set of one or more solar panels in the first section 1910 face an outward direction 1980 (e.g., away from a housing of the mobile solar generator) and are not shaded by any other solar panels of the solar array 1900. In the example of FIG. 19A, the second section 1920 and third section 1930 are shaded by the first section 1910. In some examples, each of the first 1910, second 1920, and third 1930 sections are approximately the same size, and in some examples, in a closed configuration (e.g., when a solar array is in a safe mode configuration and/or a stored solar array configuration), approximately one third of the solar panels of the solar array are unshaded by other solar panels of the solar array, and approximately two thirds of the solar panels of the solar array are shaded by other solar panels of the solar array.

As shown in the example of FIGS. 19A-19E, in some embodiments, sections of the solar array can be foldably coupled to one another such that sections fold relative to one another when moving between a stored or otherwise closed configuration (e.g., the configuration of FIG. 19A) to a deployed configuration (e.g., the configuration of FIG. 19E). For instance, as described elsewhere herein, in some examples, a controller can be configured to move a solar array from a deployed solar array configuration to a safe mode configuration. In some such examples, the safe mode can include positioning a second set of one or more solar panels underneath a first set of one or more solar panels. In some examples, positioning the second set of one or more solar panels underneath the first set of one or more solar panels can include folding the second set of one or more solar panels relative to the first set of one or more solar panels, for example, by folding the second section 1920 relative to the first section 1910, such that the second set of one or more solar panels moves to a position underneath the first set of one or more solar panels (e.g., moving from the configuration of FIG. 19E to that of FIG. 19A).

In the illustrated examples of FIGS. 19A-19E, the first section 1910 is foldably coupled to the second section 1920, and the third section 1930 is foldably coupled to the second section 1920. In the closed configuration of FIG. 19A, the top surface 1922 of the second section 1920 faces toward and covers the third section 1930. The top surface 1912 of the first section 1910 faces away from and covers the second section 1920. However, in some such examples, when the solar array is in the deployed solar array configuration (e.g., in a configuration illustrated in FIG. 19E), the top surfaces 1912, 1922, 1932 of the first 1910, second 1920, and third 1932 sections are coplanar and face the same outward direction, for example, away from a housing of the mobile solar generator.

In some examples, moving a foldable solar array from a stored solar array configuration to a deployed solar array configuration includes unfolding a folding array of solar panels such that the second set of one or more solar panels (e.g., in second section 1920) unfolds with respect to the first set of one or more solar panels (e.g., in first section 1910) from a position underneath the first set of one or more solar panels to the position not underneath the first set of one or more solar panels and a third set of one or more solar panels (e.g., in third section 1930) unfolds with respect to the second set of one or more solar panels from a position underneath the second set of one or more solar panels to a position not underneath the second set of one or more solar panels. In some such examples, the second set of one or more solar panels can unfold with respect to the first set of one or more solar panels and the third set of one or more solar panels can unfold with respect to the second set of one or more solar panels simultaneously. Simultaneous unfolding can increase the speed at which the solar array moves into the deployed configuration.

In some embodiments, solar array 1900 can include a mechanical coupling between the first 1910, second 1920, and third 1930 sections comprising the first, second, and third sets of one or more solar panels, respectively. The mechanical coupling can be configured such that each relative folding relationship between the third section 1930 and the second section 1920 corresponds to a single relative folding relationship between the second section 1920 and the first section 1910 that occurs simultaneously with the corresponding folding relationship between the third section 1930 and the second section 1920.

In some examples, second section 1920 is pivotable relative to first section 1910 about an axis, for example, shown at 1915 in FIG. 19C. In some examples, as the solar array 1900 is moved from a stored configuration to a deployed configuration, second section 1920 is configured to rotate 180° about the axis (e.g., 1915). In some examples, third section 1930 is pivotable relative to second section 1920 about a second axis, for example, shown at 1925 in FIG. 19C. In some examples, as the solar array 1900 is moved from a stored configuration to a deployed configuration, third section 1930 is configured to rotate 180° about the second axis (e.g., 1925).

In some embodiments, solar array 1900 can be moved between the configurations shown in FIGS. 19A-19E by a solar array drive system, which can be controlled by a mobile solar generator controller as described herein. In various example, solar array drive system can include one or more hydraulic actuators (e.g., one or more hydraulic pistons/cylinders) or other suitable driving mechanisms.

For example, as described herein, in some embodiments, a controller is configured to move a solar array from a deployed solar array configuration (which may include the configuration of FIG. 19E) to a safe mode configuration (which may include the configuration of FIG. 19A) or to a stored solar array configuration (which may also include the configuration of FIG. 19A). Similarly, as described herein, in some embodiments, a controller is configured to move a solar array from a stored solar array configuration or a safe mode configuration to a deployed solar array configuration.

In some examples, a safe mode configuration and a stored solar array configuration can include a closed configuration as shown in FIG. 19A. In some embodiments, the configuration of FIG. 19A corresponds to both a safe mode configuration and a stored solar array configuration, and in some such examples. In some such examples, the safe mode configuration and stored solar array configuration differ in a height of the solar array as controlled by an adjustable support pillar. In other examples, the safe mode configuration is the stored solar array configuration.

In some examples, a controller can be configured to move the solar array 1900 to any configuration between the configurations of FIGS. 19A and 19E. For instance, in some examples, one or more intermediate configurations can be selectable by a user, such as via a user interface, to cause the controller to move the solar array into the intermediate configuration. In an example embodiment, a solar array 1900 can be moved into a cleaning configuration, for instance, in response to an input at a user interface designating the cleaning configuration. The cleaning configuration can include, for example, the configuration of FIG. 19C, 19D, or 19E. Additionally or alternatively, in some examples, a cleaning configuration can include tilting the solar array to an angle (e.g., along line C in FIGS. 4A and 4B).

In some embodiments, positioning the solar array into a cleaning configuration comprises raising the solar array above the housing (e.g., via an adjustable support pillar) while the solar array is in the configuration of FIG. 19A, then moving the solar array from the configuration of FIG. 19A to the configuration of 19E, and then lowering the solar array (e.g., via the adjustable support pillar) to facilitate cleaning of the solar array. In some examples, raising the solar array prior to moving the solar array from the configuration of FIG. 19A to the configuration of FIG. 19E provides sufficient space between, for example, the first section 1910 and the housing of the mobile solar generator to permit second 1920 and third 1930 sections to move into the configuration of FIG. 19E.

The solar array 1900 of FIGS. 19A-19E further include a fourth section 1940 comprising a fourth set of one or more solar panels, a fifth section 1950 comprising a fifth set of one or more solar panels, and a sixth section 1960 comprising a sixth set of one or more solar panels. In some examples, the fourth, fifth, and sixth sections operate in the same way as the first, second, and third sections, respectively.

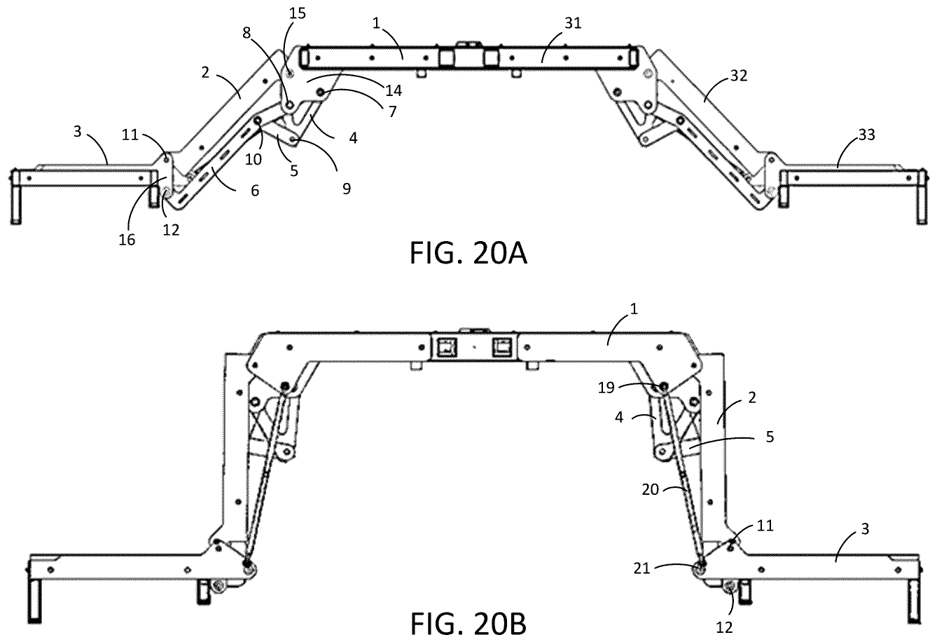

FIG. 20A shows an example solar array deployment mechanism. In the illustrated example, solar array includes a first section 1, a second section 2, and a third section 3, each of which can be configured to support one or more solar panels. In some examples, the second section 2 is pivotable relative to the first section 1 about an axis 15. As described elsewhere, in some examples, the second section can rotate 180° about the axis (e.g., 15).

In some examples, the solar array includes a four-bar linkage coupled to the first section 1 and the second section 2. In the illustrated example, the four-bar linkage comprises elements 14, 4, 5, and 6. In an example embodiment, element 4 is moved by a linear actuator (e.g., a hydraulic piston) so that element 4 rotates about an axis (e.g., about axis 7). In an example, the solar array moves toward a deployed configuration as element 4 moves clockwise in the perspective of FIG. 20A. In the example, element 4 is rotatably coupled to element 5 at axis 9, and element 5 is rotatably coupled to element 6 at axis 10. Element 6 is rotatably coupled to element 14 at axis 8. Element 6 is further rotatably coupled to element 16 at axis 12, which is rotatably coupled to section 2 at axis 11. Thus, in the illustrated example element 6 is coupled to section 2 via element 16.

In an example embodiment, as element 4 moves clockwise (e.g., due to being pushed or pulled at a point by a linear actuator), element 5 pushes upward on element 6, which moves upward and causes section 2 to pivot clockwise about axis 15, which can raise section 2 so that its top surface is approximately coplanar with a top surface of section 1. In some cases, the four-bar linkage between section 1 and section 2 allows for a full 180° pivot of section 2 about axis 15 driven by a single linear actuator (e.g., hydraulic piston) moving element 4.

In some examples, a solar array includes a second four-bar linkage coupled to the first section 1 and the third section 3. In some examples, the second four-bar linkage maintains a parallel relationship between section 1 and section 3 as the solar array moves between closed and deployed configurations. In the example of FIG. 20A, the second four-bar linkage comprises element 6, second section 2, element 16, and element 14. Thus, in some examples, the second four-bar linkage includes one or more elements in common with the first four-bar linkage discussed above.

In an example embodiment, as second section 2 moves clockwise about axis 15 (e.g., due to clockwise movement of element 4 as discussed above), it pivots about axis 11 and raises element 16, which, in turn, raises section 3. Element 16 is coupled to element 6 at axis 12, which can prevent section 3 from rotating counter-clockwise about axis 11 due to torque caused by the weight of section 3.

In some examples, the second four-bar linkage loses a mechanical advantage when element 6 and section 2 are approximately vertical. FIG. 20B shows an alternate view of the mechanism of FIG. 20A in a different deployment state. In some examples, the view of FIG. 20B is from the back of the solar array in FIG. 20A. In FIG. 20B, element 6 is obscured from view by section 2, however, both are approximately vertical. In some such examples, the mechanical advantage of the second linkage is reduced and the torque of section 3 (clockwise in FIG. 20B, counterclockwise in FIG. 20A) is not strongly opposed at axes 11 and 12. This can lead to bending or other undesirable consequences caused by the torque on section 3.

The example of FIG. 20B further includes a Schmidt linkage 20 pivotably coupled to the first section 1 at axis 19 and the third section 3 at axis 21. In some examples, the Schmidt linkage 20 provides added mechanical advantage to support the third section 3 against rotation caused by torque about axes 11 and 12 (clockwise in FIG. 20B, counterclockwise in FIG. 20A). Accordingly, in some examples, the second four-bar linkage maintains a parallel relationship between first section 1 and third section 3 as the array moves between closed and deployed configurations. However, in some such examples, a Schmidt linkage provides supplementary support for maintaining this relationship through various phases of the movement of the solar array (e.g., such as in the configuration of FIG. 20B).

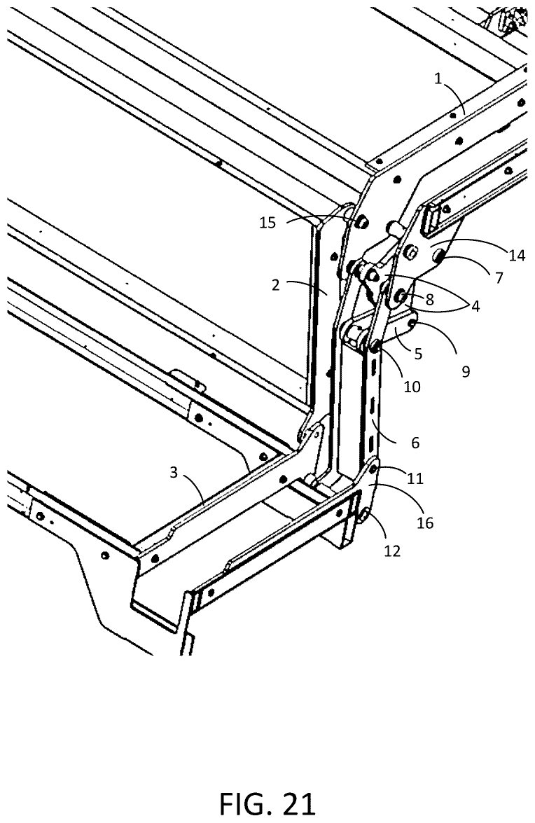

In some embodiments, various aspects of the solar array comprise a width such that adjoining components (e.g., components pivotably coupled at an axis) have different widths and one component effectively fits inside of another. FIG. 21 shows a perspective view of the solar array assembly of FIG. 20A. As shown, for example, element 5 is coupled to element 6 at axis 10, at which point element 5 is within element 6. Similarly, element 4 is coupled to element 5 at axis 9, at which point element 4 is within element 5. However, not all components necessarily surround or are within an adjoining element.

In some examples, a solar array comprises two half-arrays, wherein each of the half arrays is movable between a closed configuration and a deployed configuration. In some such examples, each of the half arrays is movable by a single hydraulic cylinder, such as described herein. For example, in the example of FIG. 20A, the solar array includes fourth section 31, fifth section 32, and sixth section 33. In some examples, the fourth 31, fifth 32, and sixth 33 sections operate in a similar way as described above with respect to first 1, second 2, and third 3 sections. For example, in some embodiments, the solar array comprises a third four-bar linkage configured to cause fifth section 32 to pivot 180° about an axis with respect to fourth section 31. Additionally or alternatively, in some embodiments, the solar array comprises a fourth four-bar linkage configured to maintain a parallel relationship between the sixth section 33 and the fourth section 31 as the solar array moves between stored and deployed configurations. A second Schmidt linkage coupled to the fourth section and the sixth section 33 can be used to supplement the fourth four-bar linkage.

In some examples, a controller is configured to move two half arrays between a closed configuration and a deployed configuration simultaneously. Additionally or alternatively, in some examples, a controller is configured to move each half array individually. A mobile solar generator controller can cause either or both half arrays to move between the closed and deployed configurations for a variety of reasons, for example, in response to a user command or wind information provided from a wind sensor. For moving the arrays between the closed and deployed configurations can include, the controller can be configured to control motion of a respective hydraulic cylinder associated with each half array.

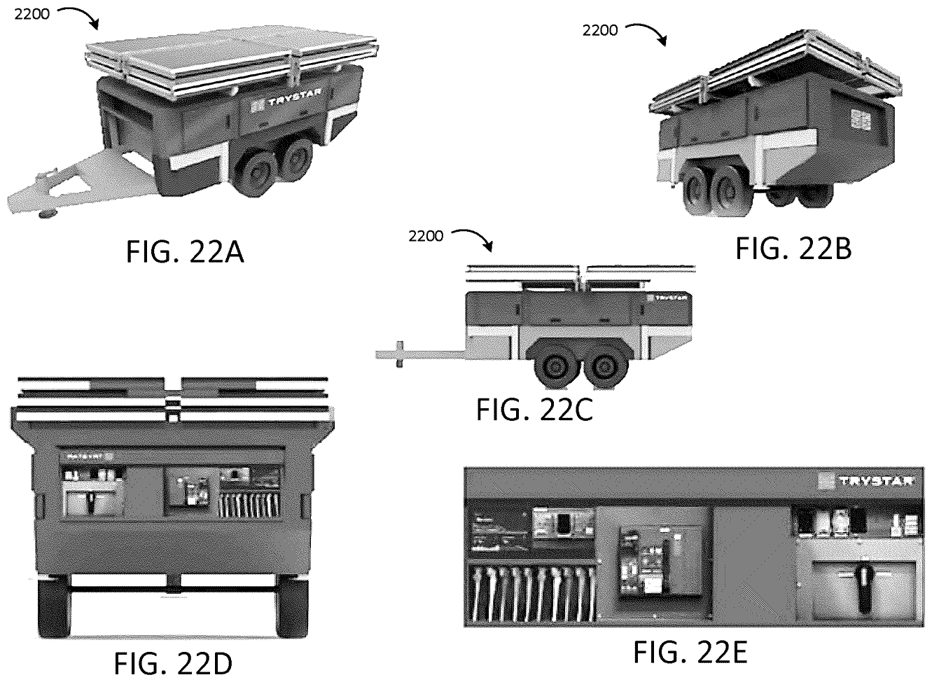

As described, in some embodiments, a solar array can include a plurality of solar panels that can be expanded or reduced in size, for example, for increasing the solar power generation capacity or transported, respectively. FIGS. 22A-22E are perspective views of an example mobile solar generator in a closed configuration according to an aspect of the present disclosure. The mobile solar generator 2200 includes a series of collapsed or folded solar panels on top of a housing, which can be configured as a pull-behind unit. The mobile solar generator 2200 also includes outriggers which can be configured to retract into the housing, for example, such as shown in FIG. 22A. The mobile solar generator 2200 can further include additional electrical components such as batteries, inverters, load connections, circuit breakers, switches, etc. as described herein. For instance, as illustrated in FIG. 22E, the mobile solar generator 2200 can include camlock connections, outlet connections, switches, and interfaces. In some examples, an interface can include a display which can display information about the mobile solar generator 2200, for example, such as power being generated, battery charge level, the load level, and other information.

As described herein, in some examples, a mobile solar generator can include one or more electrical inputs in addition to its electrical outputs. As described, in various embodiments, the one or more electrical inputs can be used to charge the batteries of the mobile solar generator using an external source without using the integrated power generation of the mobile solar generator (e.g., solar panels, generator, etc.). For instance, in the embodiment of FIG. 22E, one or more of the camlock connections can connect to an external power source, such as a shore power source, and receive electrical power therefrom. Such received electrical power can be provided to one or more batteries to charge such batteries.

In various embodiments, a mobile solar generator can include multiple storage areas integrated into the housing for storing items such as hand tools, cables, power distribution devices, fuel storage, and the like. In some examples, the storage areas include internal cabinets and drawers.

In some examples, mobile solar generator can be pulled-behind a tow vehicle and can include features such as directional signals, brake lights, and the like in order to comply with roadway requirements for being towed. Additionally, a mobile solar generator can include brakes for its wheels that are independent from a tow vehicle's brakes. In some examples, a mobile solar generator can be configured to stand by itself independent of the tow vehicle (e.g., via outriggers in the deployed outrigger configuration such as shown in FIG. 3).

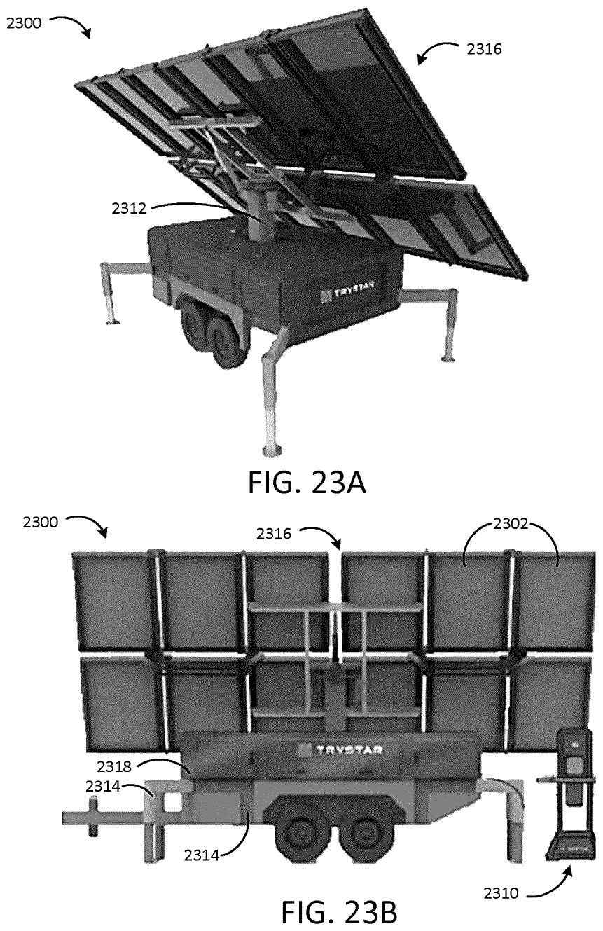

Moving to FIGS. 23A-23B, FIGS. 23A-23B are perspective views of an example mobile solar generator in an open configuration according to an aspect of the present disclosure. As illustrated, the mobile solar generator 2300 has outriggers 2314 that extend from a housing to provide extra stability to the mobile solar generator 2300 to which solar array 2316 comprising a series of solar panels are attached. In some examples, outriggers swing out from a recessed channel 2315 in a housing 2318 of the mobile solar generator 2300.

As described, in some examples, such a series of solar panels 2302 can be attached to an adjustable support pillar 2312 with multi-axis pivot which can change heights, rotate about its axis, and tilt the series of solar panels. As shown in the illustrated example, support pillar 2312 can include a rectangular cross-section, and in some embodiments, the rectangular cross-section comprises a square cross-section. Further, in FIG. 23B, the mobile solar generator 2300 can include, or be connected to, a power distribution station 2310. The power distribution station can provide a convenient place for people to connect to the electrical power being generated by the mobile solar generator 2300. Example power distribution stations can include standard outlets and/or other, higher power outlets or connectors. Example outputs can include various NEMA outlets (e.g., 5-15, 5-20, 5-30, 5-50) outlets or connections such as camlocks.

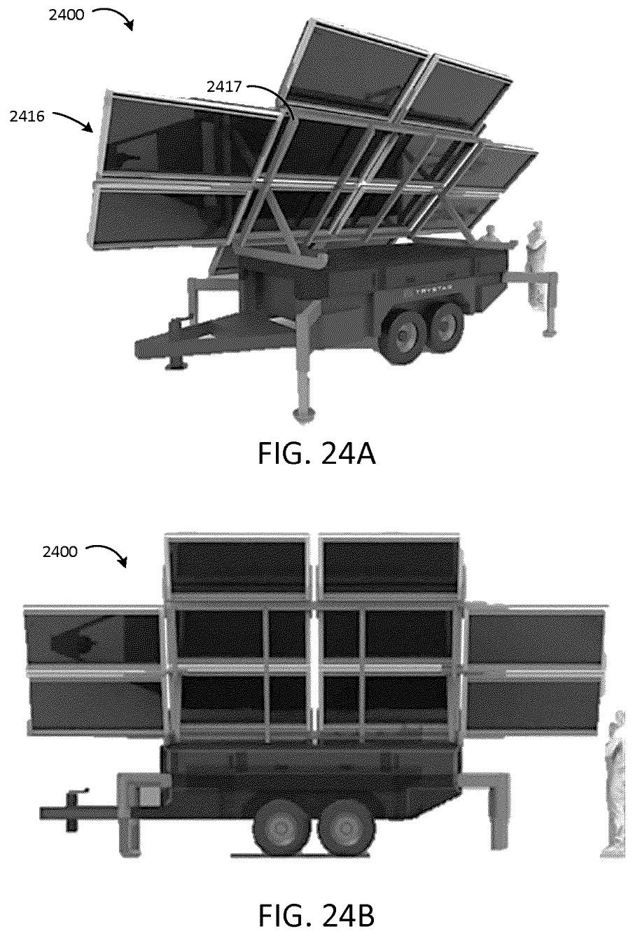

Moving to FIGS. 24A-24B, FIGS. 24A-24B are perspective views of an example mobile solar generator in an open configuration according to an aspect of the present disclosure. The mobile solar generator 2400 of FIGS. 24A-24B is similar to that of the mobile solar generator 2300 of FIGS. 23A-23B. However, instead of mounting the series of solar panels to an adjustable support pillar with multi-axis pivot, a solar array 2416 including a series of solar panels is mounted to a rack 2417. In some examples, the rack has a fixed angle, while in some alternate examples, the rack can be manually or automatically tilted. While in some cases, a mobile solar generator such as shown in FIGS. 24A-24B may not be able to track the sun's path as accurately as a mobile solar generator such as shown in FIGS. 23A-23B, the design can be simpler, cost less, and can be adequate for an amount of electrical generation needed. Further in the illustrated design, the series of solar panels can be folded in/out for storage or deployment respectively.

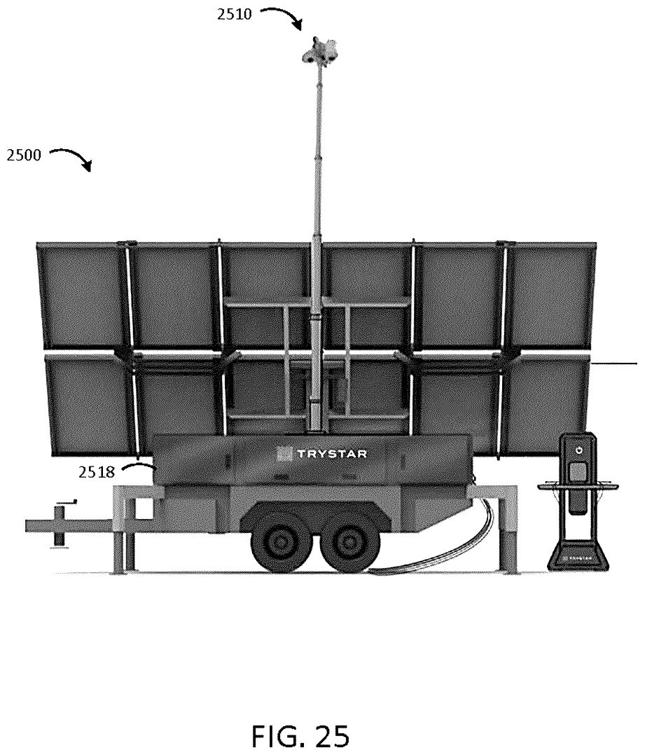

Moving to FIG. 25, FIG. 25 is a perspective view of an example mobile solar generator in an open configuration with a sensor tower according to an aspect of the present disclosure. The sensor tower 2510 can include a variety of sensors including but not limited to, wind sensors, solar irradiance sensors, audio/visual sensor (e.g., security camera, microphones), and thermal sensors. Sensor tower can also include one or more antennae such as a cellular data antenna or a GPS antenna. Including a sensor tower with the mobile solar generator can be advantageous as it can provide important data related to the operation of the solar generator. For example, as described herein, in some embodiments, having a wind sensor on the sensor tower can provide windspeed which can inform if it is safe to have the mobile solar generator in various configurations, such as a fully open/deployed configuration. In some examples, the sensor tower is extendable/retractable from the mobile solar generator. In the illustrated example of FIG. 25, sensor tower is configured to extend from a housing 2518 of mobile solar generator 2500. As described elsewhere herein, in some examples, a sensor tower is configured to be coupled to a solar array, such as shown in FIGS. 4A-4B.

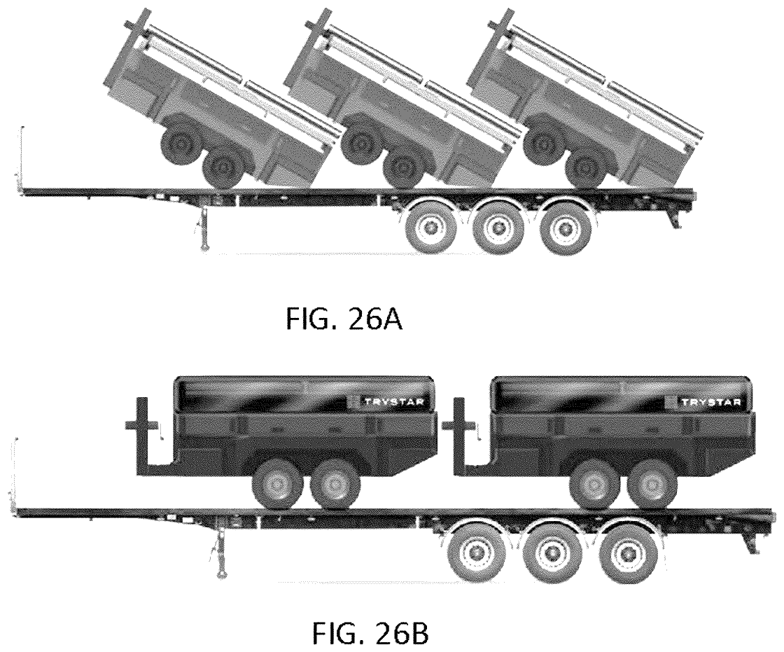

Moving to FIGS. 26A-26B, FIGS. 26A-26B are perspective views of multiple example mobile solar generators transported on a pull-behind unit according to an aspect of the present disclosure. The mobile solar generators as shown can include a cover as in FIG. 26B with a trailer connecting portion being non-retractable. In some examples, though, the mobile solar generators do not include a cover and have a retractable trailer connecting portion as in FIG. 26A. In some examples, the wheels of the mobile solar generator are semi-retractable whereby they can collapse further into the mobile solar generator. More than one mobile generator can be carried on a larger trailer such as a trailer pulled by a semi-truck.

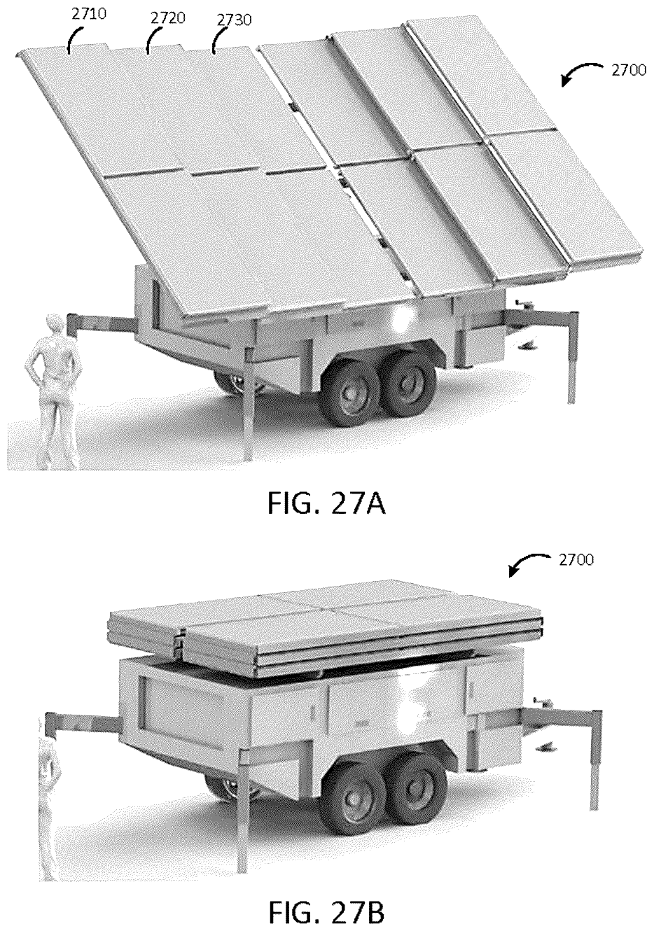

Moving to FIGS. 27A-27B, FIGS. 27A-27B are perspective views of an example mobile solar generator with a sliding array of solar panels in both an open configuration and a closed configuration according to an aspect of the present disclosure. The series of solar panels on the mobile solar generator 2700 are configured to deploy from the closed configuration of FIG. 27B to the open configuration of FIG. 27A. In the illustrated example of FIG. 27B, a first section 2710 of the solar array includes topmost solar panels can slide laterally outward from the center of the mobile solar generator 2700. Subsequently, a second section 2720 of the solar array includes middle solar panels that can slide laterally outward from the center of the mobile solar generator 2700. As the topmost solar panels are also connected to the middle solar panels, when the middle solar panels slide laterally outward, so to do the topmost solar panels. In some examples, the middle solar panels are slid laterally outward before the topmost solar panels are slid laterally outward.

The illustrated example also shows third section 2730 of the solar array that includes bottom solar panels. In an example embodiment, the bottom solar panels remain stationary as the topmost and middle solar panels slide laterally outward.

In some examples, the solar array of FIGS. 27A-B is configured to move between a closed configuration wherein the third section is covered by the second section and the second section is covered by the first section and a deployed configuration wherein none of the first, second, or third sections are covered by any other of the first, second, or third sections. In some such examples, in the deployed configuration, a top surface of each of the first, second, and third section face an outward direction.

As in the example mobile solar generator of FIGS. 4A-4B, the series of solar panels can be mounted on an adjustable support pillar with multi-axis pivot that can adjust the height, direction, and tilt of the series of solar panels. For example, once the series of solar panels are all slid laterally outward, the adjustable support pillar with multi-axis pivot can lift, rotate, and tilt the solar panels, as illustrated in FIG. 27A. In some examples, the solar panels can lock into position after sliding laterally outward to keep the solar panels in the open/deployed configuration. In some examples, the solar panels slide laterally outward manually, however, in some examples, the solar panels slide laterally outward via an automatic sliding mechanism (e.g., with motors). In some such examples, the sliding mechanism can include hydraulics which can be controlled automatically and/or by an operator.

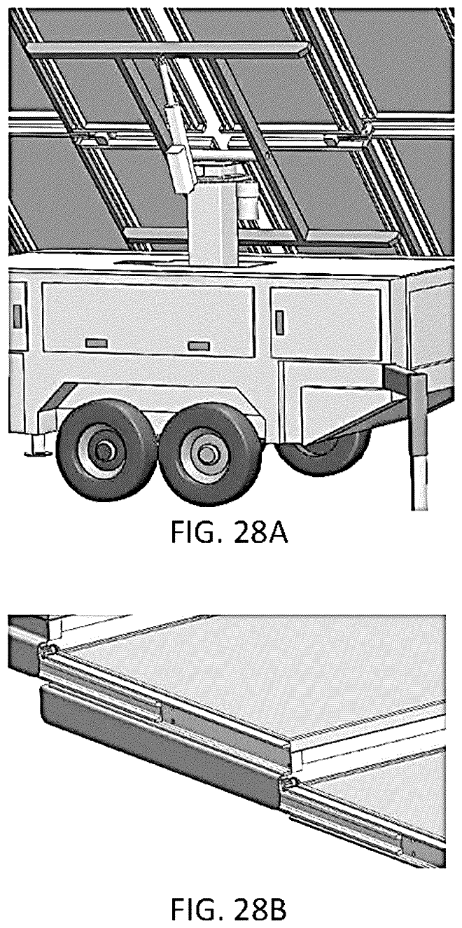

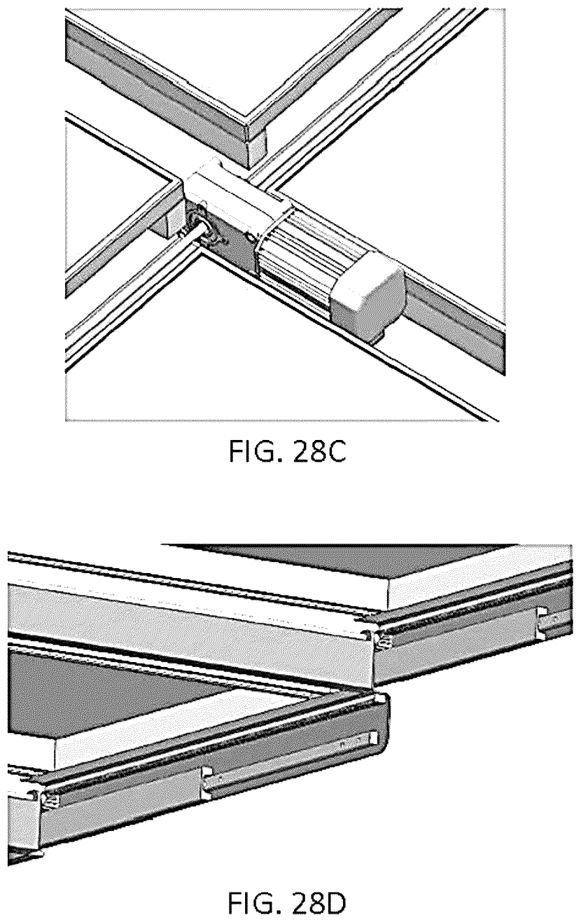

Moving to FIGS. 28A-28D, FIGS. 28A-28D are perspective views of an example sliding mechanism for an array of solar panels according to an aspect of the present disclosure. As illustrated in FIGS. 28B-28D, the sliding mechanism can connect multiple solar panels together with a top solar panel slidable relative to a middle solar panel which is slidable relative to a bottom solar panel. The sliding mechanism can include bearings/rollers along with brackets on each side of the solar panels which are configured to secure one solar panel with another solar panel and enable a slidable interconnection therebetween. Having a sliding mechanism can enable the solar panels to retract from an expanded, open configuration to a retracted, closed configuration which is easier for transportation.

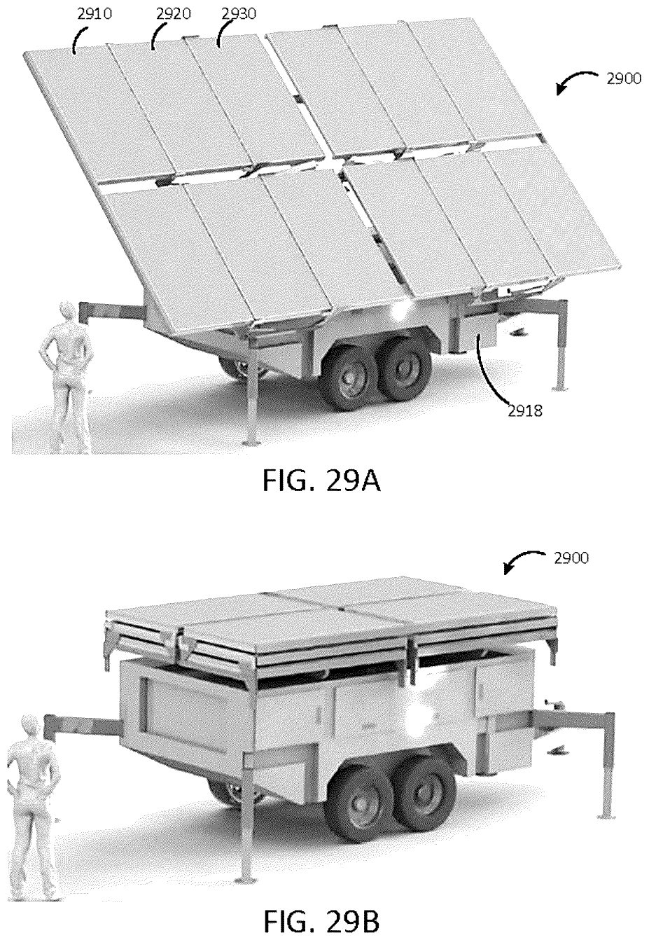

Moving to FIGS. 29A-29B, FIGS. 29A-29B are perspective views of an example mobile solar generator with a folding array of solar panels in both an open configuration and a closed configuration according to an aspect of the present disclosure. The series of solar panels on the mobile solar generator are configured to deploy from the closed configuration of FIG. 29B to the open configuration of FIG. 29A. In the illustrated example of FIG. 29B, a first section 2910 including topmost solar panels can fold laterally outward from the center of the mobile solar generator 2900. Subsequently, a second section 2920 including middle solar panels can fold laterally outward from the center of the mobile solar generator 2900. As the topmost solar panels are also connected to the middle solar panels, when the middle solar panels fold laterally outward, so to do the topmost solar panels. In some examples, the middle solar panels are folded laterally outward before the topmost solar panels are folded laterally outward.

The illustrated example also shows third section 2930 of the solar array that includes bottom solar panels. In an example embodiment, the bottom solar panels remain stationary as the topmost and middle solar panels fold laterally outward.

In some examples, the solar array of FIGS. 29A-29B is configured to move between a closed configuration wherein the third section 2930 is covered by the second section 2920 and the second section 2920 is covered by the first section 2910 and a deployed configuration wherein none of the first 2910, second 2920, or third 2930 sections are covered by any other of the first, second, or third sections. In some such examples, in the deployed configuration, a top surface of each of the first, second, and third section face an outward direction (e.g., away from a housing 2918 of the mobile solar generator 2900).

As in the example mobile solar generator of FIGS. 24A-24B, the series of solar panels can be mounted on an adjustable support pillar with multi-axis pivot that can adjust the height, direction, and tilt of the series of solar panels. For example, once the series of solar panels are all folded laterally outward, the adjustable support pillar with multi-axis pivot can lift, rotate, and tilt the solar panels, as illustrated in FIG. 27A. In some examples, the solar panels can lock into position after folding laterally outward to keep the solar panels in the open/deployed configuration. In some examples, the solar panels fold laterally outward manually, however, in some examples, the solar panels fold laterally outward via an automatic folding mechanism (e.g., with motors). In some such examples, the folding mechanism can include hydraulics which can be controlled automatically and/or by an operator.

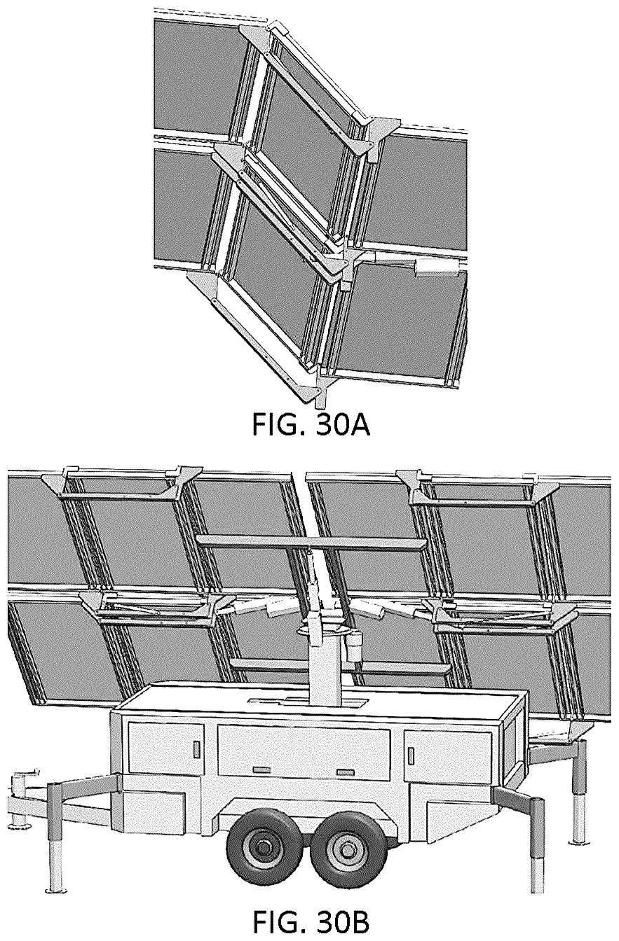

Moving to FIGS. 30A-30B, FIGS. 30A-30B are perspective views of an example folding mechanism for an array of solar panels according to an aspect of the present disclosure. As illustrated in FIGS. 30A-30B, the folding mechanism can connect multiple solar panels together with a first section including a top solar panel foldable relative to a second section including a middle solar panel which is foldable relative to a third section including a bottom solar panel. The folding mechanism can include hinges, supports, locks, and brackets to enable foldable connection between solar panels. For example, FIGS. 30A and 30B, three folding brackets are attached to the topmost and bottom most solar panels allowing them to fold relative to each other. In some examples, the folding mechanism can include one or more motors to enable folding/retraction of the solar panels. Having a folding mechanism can enable the solar panels to retract from an expanded, open configuration (e.g., in a deployed solar array configuration) to a retracted, closed configuration (e.g., a stored solar array configuration), which is easier for transportation. In some examples, a different folding mechanism can be used. In some such examples, the folding mechanism can be configured to have the topmost solar panels fold laterally inward onto the middle solar panels first, before the combined topmost and middle solar panels fold laterally inward relative to the bottom most solar panels.

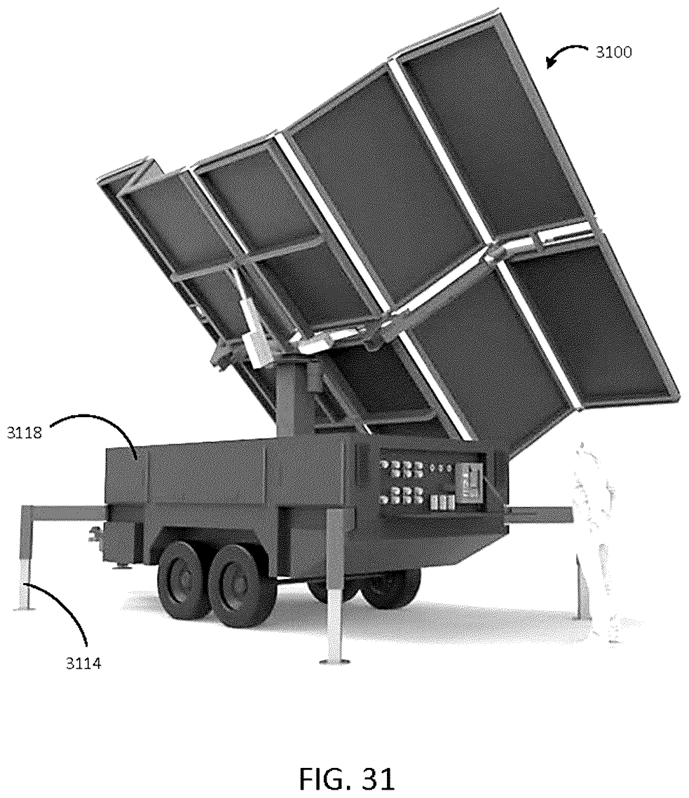

Moving to FIG. 31, FIG. 31 is a perspective view of an example mobile solar generator with a folding array of solar panels in a half-way open configuration according to an aspect of the present disclosure. In the illustrated folding mechanism, the innermost solar panels are stationary while the middle and outermost solar panels are foldable relative to the innermost solar panels. Further, the middle solar panels fold such that their solar generating face folds laterally inward onto the solar generating face of the innermost solar panels.

Additionally in FIG. 31, the housing 3118 of the mobile solar generator 3100 also includes electrical connections, switches, displays, and other interface devices which a person can monitor/operate. The interface devices can allow a user to control varies aspects of the mobile solar generator 3100 such as the deployment of the solar panels, the height and orientation of the solar panels, the extension and leveling operation of the outriggers 3114, power generation/output, and the like. Further, the interface devices can allow a user to monitor various aspects of the mobile solar generator 3100 such as line input power, solar power generated, output power, battery input/output power, battery charge level, wind speed, sun irradiance, temperature, GPS location, solar panel deployment status, and visual information (e.g., from a camera). In some embodiments, the mobile solar generator 3100 can be remotely controlled and/or monitored including all the controls and measurements listed above. A person having ordinary skill in the art will appreciate that other controls and measurements are contemplated, and that this disclosure is not limited to the listed examples.

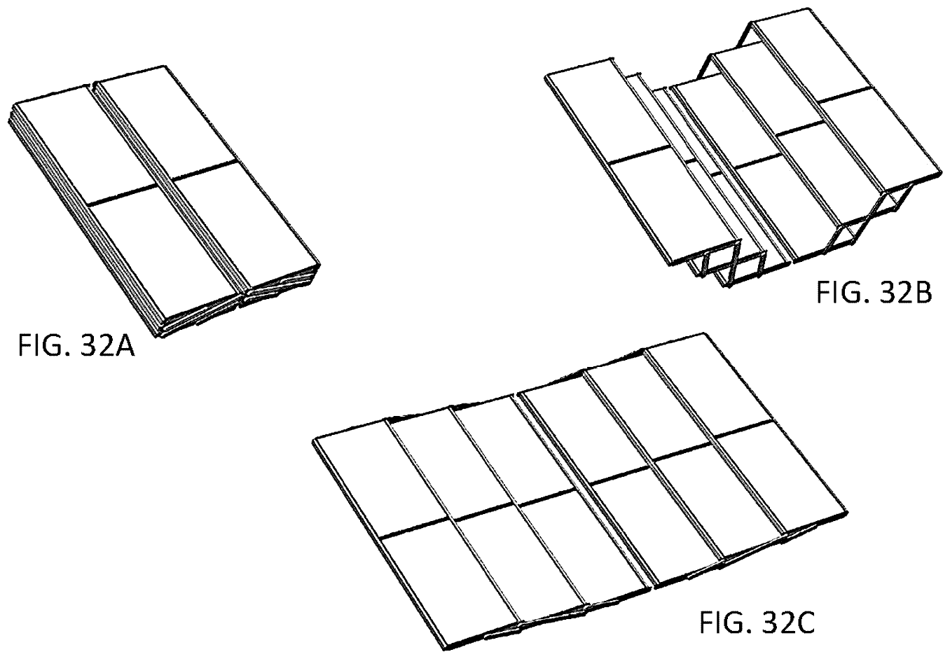

Moving to FIGS. 32A-32C, FIGS. 32A-32C are perspective views of an example folding array of solar panels unfolding according to an aspect of the present disclosure. In contrast to the folding mechanisms illustrated in other figures, the folding mechanism illustrated in FIGS. 32A-32C uses scissor-like folding. With such a folding mechanism, all the solar panels are folded on top of each other with the solar generating face of each solar panel being covered by a non-solar generating face of a solar panel. This contrasts with the folding mechanism illustrated in FIGS. 29A-29B and FIG. 31. A person having ordinary skill in the art will appreciate that other folding mechanisms are contemplated, and that this disclosure is not limited to the illustrated examples.

Example mobile solar generators described herein can provide a variety of advantages. Some mobile solar generators described herein may be positioned at locations in which a typical diesel generator would be too loud and/or prohibited due to emissions, smell, etc. As described herein, some mobile solar generators can be deployed and/or retracted in less than a predetermined period of time (e.g., 15 minutes).

In some examples, as described elsewhere herein, some mobile solar generators include a high wind retraction feature in which a controller determines that wind levels (e.g., as measured by a wind sensor) exceed a predetermined threshold and causes the array of solar panels to move into an alternate configuration (e.g., a safe mode configuration and/or a stored solar array configuration). The high wind retraction feature can alleviate the need to have an operator visit a site and manually retract the array of solar panel for each mobile solar generator. In some mobile solar generators described herein, when the array of solar panels is deployed, all of the solar panels in the array are exposed to the sun, and when the array of solar panels is retracted, a subset of the solar panels (e.g., four of twelve) are nevertheless exposed to the sun. In this way, the mobile solar generator may be taking in solar energy even when the array of solar panels is retracted.

In general, the example mobile solar generators described herein can be configured to provide protection from environmental factors such as precipitation, dirt, wind, and temperature. Further, the example mobile generators are configured to operate in a variety of conditions.

Various examples of the disclosure have been described. Any combination of the described systems, operations, or functions is contemplated.

1. A mobile solar generator comprising:
a housing;
an adjustable support pillar coupled to the housing and configured to extend upward from the housing;
a solar array;
a solar array drive system comprising one or more motors; and
a multi-axis pivot connecting the solar array to the adjustable support pillar such that:
the solar array drive system is configured to move the solar array about at least two axes relative to the adjustable support pillar; and
a height of the solar array is adjustable via the adjustable support pillar.

2. (canceled)

3. The mobile solar generator of claim 1, further comprising a controller in communication with the solar array drive system and configured to control the one or more motors to selectively move the solar array about one or more of the at least two axes.

4. The mobile solar generator of claim 3, wherein the controller is configured to cause the solar array drive system to move the solar array to track motion of the sun.

5. The mobile solar generator of claim 4, wherein the controller is configured to determine a motion path for the solar array to track the motion of the sun.

6. The mobile solar generator of claim 5, further comprising a compass and a global positioning system (GPS), and wherein the controller is configured to:
receive position information from the GPS;
receive direction information from the compass; and
determine the motion path for the solar array to track the motion of the sun based on the position information and the direction information.

7. The mobile solar generator of claim 6, further comprising a clock and a calendar, and wherein the controller is configured to:
receive time-of-day information from the clock;
receive date information from the calendar; and
periodically update an orientation of the solar array to move the solar array along the motion path based on the time-of-day information and the date information.

8. The mobile solar generator of claim 7, wherein periodically updating the orientation of the solar array comprises, at predetermined intervals:
determining an updated preferred orientation of the solar array based on the position information, the direction information, the time-of-day information, and the date information; and
adjusting the orientation of the solar array to the updated preferred orientation via the solar array drive system.

9. The mobile solar generator of claim 8, where the controller is configured to adjust the orientation of the solar array at a rate of between once every 10 minutes and once every 60 minutes.

10. The mobile solar generator of claim 7, wherein the controller is configured to determine if the time of day is within a predetermined window of time, and, periodically updating the orientation of the solar array only if the time of day is within the predetermined window of time.

11. The mobile solar generator of claim 10, wherein the controller is configured to determine the predetermined window of time based on the date information.

12. The mobile solar generator of claim 1, wherein the solar array comprises a plurality of solar panels.

13. The mobile solar generator of claim 12, wherein the plurality of solar panels are arranged in an array configured to be deployed from a closed configuration, wherein a subset of the plurality of solar panels are shaded by one or more of the plurality of solar panels, to an open configuration, in which none of the plurality of solar panels shades another of the plurality of solar panels.

14. A method comprising:
transporting a mobile solar generator to a location, the mobile solar generator comprising a solar array and an adjustable support pillar supporting the solar array;
raising the solar array vertically from a lowered position to a raised position via the adjustable support pillar;
determining a facing direction of the mobile solar generator based on information received from a compass;
tilting the solar array about a first axis of rotation relative to the adjustable support pillar and rotating the solar array about a second axis of rotation relative to the adjustable support pillar to position the solar array in a first orientation, the first orientation being based on the facing direction;
tilting the solar array about the first axis of rotation relative to the adjustable support pillar and rotating the solar array about the second axis of rotation relative to the adjustable support pillar to position the solar array in a second orientation different from the first.

15. The method of claim 14, further comprising:
determining a coordinate position of the mobile solar generator based on information received from a global positioning system (GPS); and
determining a motion path for the solar array to track motion of the sun based on the facing direction and the coordinate position, the motion path comprising a plurality of orientations of the solar array.

16. The method of claim 15, further comprising determining a date based on information received from a calendar, and wherein determining the motion path for the solar array to track the motion of the sun is further based on the date.

17. The method of claim 16, further comprising:
determining a time of day based on information received from a clock; and
moving the solar array to a predetermined orientation along the motion path based on the time of day.

18. The method of claim 15, further comprising:
adjusting an orientation of the solar array to each of the plurality of orientations along the motion path by tilting the solar array about the first axis of rotation relative to the adjustable support pillar and rotating the solar array about the second axis of rotation relative to the adjustable support pillar, the plurality of orientations comprising the first orientation and the second orientation.

19. The method of claim 18, wherein adjusting the orientation of the solar array to each of the plurality of orientations along the motion path comprises adjusting the orientation of the solar array at a predetermined frequency.

20. The method of claim 19, wherein adjusting the orientation of the solar array at the predetermined frequency comprises adjusting the orientation of the solar array at a rate of between once every 10 minutes and once every 60 minutes.

21-170. (canceled)

171. The mobile solar generator of claim 1, wherein the housing comprises a battery compartment and one or more batteries housed within the battery compartment, and wherein the battery compartment comprising a climate control system configured to control one or more aspects of an environment within the battery compartment.

172. The mobile solar generator of claim 171, wherein the climate control system is configured to cause air to flow through the battery compartment.

173. The mobile solar generator of claim 172, wherein the climate control system includes a refrigerant circuit configured to condition the air that flows through the battery compartment.

174. The mobile solar generator of claim 171, further comprising a temperature sensor configured to output a signal representative of a temperature of the battery compartment, and wherein the climate control system is configured to selectively heat or cool the battery compartment in order to maintain the temperature within the battery compartment within a predetermined temperature range.

175. The mobile solar generator of claim 171, further comprising an inverter, wherein the housing includes an inverter compartment configured to hold the inverter.

176. The mobile solar generator of claim 171, further comprising a generator configured to generate electrical energy and a compartment of the housing configured to hold a reservoir of fuel for the generator.

177. The mobile solar generator of claim 176, wherein the generator is configured to generate electrical energy from a non-renewable source.

178. The mobile solar generator of claim 176, wherein the generator comprises a propane generator, a diesel generator, or a fuel cell.

179. The mobile solar generator of claim 176, wherein the controller is configured to cause the generator to provide electrical energy directly to an external load.

180. The mobile solar generator of claim 176, wherein the controller is configured to cause the generator to provide electrical energy to the one or more batteries.

181. The mobile solar generator of claim 180, wherein the controller is configured to determine a state of charge of the one or more batteries, and, if the state of charge is below a threshold state of charge, then cause the generator to provide electrical energy to the one or more batteries.

182. The mobile solar generator of claim 181, wherein the controller is configured to determine an amount of energy provided to the one or more batteries from the solar array, and if the state of charge of the one or more batteries is below the threshold state of charge and if the amount of energy provided to the one or more batteries from the solar array is below a threshold amount of energy, then cause the generator to provide electrical energy to the one or more batteries.

183. The mobile solar generator of claim 181, wherein the threshold state of charge is adjustable by a user.

184. The mobile solar generator of claim 1, wherein the adjustable support pillar is rotatable about a vertical axis of rotation.

185. The mobile solar generator of claim 184, wherein the adjustable support pillar comprises a rectangular cross section.

186. The mobile solar generator of claim 184, wherein the solar array is configured to rotate about the vertical axis of rotation by ±175° from a neutral position.

187. The mobile solar generator of claim 1, wherein the solar array is configured to tilt about a first axis of rotation between elevation angles of 0° and 50°.

188. The method of claim 14, further comprising controlling one or more aspects of an environment within a battery compartment via a climate control system.

189. The method of claim 188, further comprising causing air flow through the battery compartment.

190. The method of claim 189, wherein the climate control system includes a refrigerant circuit configured to condition the air that flows through the battery compartment.

191. The method of claim 190, further comprising:
sensing a temperature representative of the battery compartment via a temperature sensor; and
in response to the sensed temperature, selectively heating or cooling the battery compartment in order to maintain the temperature within the battery compartment within a predetermined temperature range.

192. The method of claim 14, further comprising generating electrical energy using a generator, and wherein generating electrical energy using a generator comprises generating electrical energy from a non-renewable source.

193. The method of claim 192, further comprising providing electrical energy directly to an external load from the generator.

194. The method of claim 192, further comprising providing electrical energy from the generator to one or more batteries.

195. The method of claim 194, further comprising:
determining a state of charge of the one or more batteries; and
if the state of charge is below a threshold state of charge, causing the generator to provide electrical energy to the one or more batteries.

196. The method of claim 195, further comprising:
determining an amount of energy provided to the one or more batteries from the solar array; and
if the state of charge of the one or more batteries is below the threshold state of charge and if the amount of energy provided to the one or more batteries from the solar array is below a threshold amount of energy, causing the generator to provide electrical energy to the one or more batteries.

197. The method of claim 196, further comprising adjusting the threshold state of charge.

198. The method of claim 14, further comprising rotating the adjustable support pillar about a vertical axis of rotation by ±175° from a neutral position.

199. The method of claim 17, wherein moving the solar array to the predetermined orientation comprises tilting the solar array relative to the adjustable support pillar to an elevation angle of between 0° and 50°.
